(19) United States
(12) Patent Application Publication
(10) Pub. No.: US 2025/0373300 A1
(43) Pub. Date: Dec. 4, 2025

(54) TECHNIQUES FOR COHERENT JOINT TRANSMISSION ACROSS MULTIPLE TRANSMISSION-RECEPTION POINT SETS

(71) Applicant: QUALCOMM INCORPORATED, San Diego, CA (US)

(72) Inventors: Chao Wei, Beijing (CN); Jing Dai, Beijing (CN); Hao Xu, Beijing (CN)

(21) Appl. No.: 18/876,580

(22) PCT Filed: Aug. 12, 2022
(86) PCT No.: PCT/CN2022/111970

§ 371 Date: Dec. 18, 2024

(51) Int. Cl. H04B 7/06; H04B 7/024; H04W 24/10; H04W 72/20

(52) U.S. Cl. CPC H04B 7/0626; H04B 7/024; H04W 24/10; H04W 72/20

(57) ABSTRACT

Methods, systems, and devices for wireless communications are described. A user equipment (UE) may receive control signaling indicating multiple transmission-reception points (TRPs), and may perform measurements for reference signals received from the multiple TRPs within a set of measurement resources. The UE may transmit a channel state information (CSI) report including a first CSI part and a second CSI part, where at least one of the first CSI part or the second CSI part indicates a first mapping between a first set of TRPs and a first set of spatial multiplexing layers, and a second mapping between a second set of TRPs and a second set of spatial multiplexing layers. The UE may then receive a phase-coherent joint transmission of a downlink message from the first set of TRPs in accordance with the first mapping, or from the second set of TRPs in accordance with the second mapping.

### CROSS REFERENCE

The present Application is a 371 national stage filing of International PCT Application No. PCT/CN2022/111970 by Wei et al. entitled “TECHNIQUES FOR COHERENT JOINT TRANSMISSION ACROSS MULTIPLE TRANSMISSION-RECEPTION POINT SETS,” filed Aug. 12, 2022, which is assigned to the assignee hereof, and which is expressly incorporated by reference in its entirety herein.

### FIELD OF TECHNOLOGY

The following relates to wireless communications, including techniques for coherent joint transmission (CJT) across multiple transmission-reception point (TRP) sets.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications support coherent joint transmissions (CJTs) in which a message is transmitted coherently (e.g., with a same phase) across multiple transmission-reception points (TRPs). For example, a first TRP and a second TRP may transmit a same downlink message such that the downlink message exhibits phase coherency across both the respective TRPs. However, CJTs may result in increased complexity when it comes to channel state information (CSI) reporting.

### SUMMARY

The described techniques relate to improved methods, systems, devices, and apparatuses that support techniques for coherent joint transmission (CJT) across multiple transmission-reception point (TRP) sets. Generally, aspects of the present disclosure support configurations, rules, and signaling for separating multiple TRPs into defined sets of TRPs for coherent joint transmissions (CJTs) for multi-TRP (mTRP) transmissions in order to reduce CSI reporting complexity at user equipments (UEs). In other words, aspects of the present disclosure may enable TRPs to be grouped into respective TRP sets that support differing quantities of spatial multiplexing layers. The grouping of TRPs for CJTs may be determined by the network, or by the UE.

A method for wireless communication at a UE is described. The method may include receiving control signaling indicating a set of multiple TRPs and a set of measurement resources, performing measurements for a set of multiple reference signals received from the set of multiple TRPs within the set of measurement resources, transmitting a channel state information (CSI) report including a first CSI part and a second CSI part, at least one of the first CSI part or the second CSI part indicating a first mapping between a first set of TRPs of the set of multiple TRPs and a first set of spatial multiplexing layers, and indicating a second mapping between a second set of TRPs of the set of multiple TRPs and a second set of spatial multiplexing layers based on the measurements, and receiving a phase-coherent joint transmission of a downlink message from the first set of TRPs in accordance with the first mapping, or from the second set of TRPs in accordance with the second mapping.

An apparatus for wireless communication at a UE is described. The apparatus may include a processor, memory coupled with the processor, and instructions stored in the memory. The instructions may be executable by the processor to cause the apparatus to receive control signaling indicating a set of multiple TRPs and a set of measurement resources, perform measurements for a set of multiple reference signals received from the set of multiple TRPs within the set of measurement resources, transmit a CSI report including a first CSI part and a second CSI part, at least one of the first CSI part or the second CSI part indicating a first mapping between a first set of TRPs of the set of multiple TRPs and a first set of spatial multiplexing layers, and indicating a second mapping between a second set of TRPs of the set of multiple TRPs and a second set of spatial multiplexing layers based on the measurements, and receive a phase-coherent joint transmission of a downlink message from the first set of TRPs in accordance with the first mapping, or from the second set of TRPs in accordance with the second mapping.

Another apparatus for wireless communication at a UE is described. The apparatus may include means for receiving control signaling indicating a set of multiple TRPs and a set of measurement resources, means for performing measurements for a set of multiple reference signals received from the set of multiple TRPs within the set of measurement resources, means for transmitting a CSI report including a first CSI part and a second CSI part, at least one of the first CSI part or the second CSI part indicating a first mapping between a first set of TRPs of the set of multiple TRPs and a first set of spatial multiplexing layers, and indicating a second mapping between a second set of TRPs of the set of multiple TRPs and a second set of spatial multiplexing layers based on the measurements, and means for receiving a phase-coherent joint transmission of a downlink message from the first set of TRPs in accordance with the first mapping, or from the second set of TRPs in accordance with the second mapping.

A non-transitory computer-readable medium storing code for wireless communication at a UE is described. The code may include instructions executable by a processor to receive control signaling indicating a set of multiple TRPs and a set of measurement resources, perform measurements for a set of multiple reference signals received from the set of multiple TRPs within the set of measurement resources, transmit a CSI report including a first CSI part and a second CSI part, at least one of the first CSI part or the second CSI part indicating a first mapping between a first set of TRPs of the set of multiple TRPs and a first set of spatial multiplexing layers, and indicating a second mapping between a second set of TRPs of the set of multiple TRPs and a second set of spatial multiplexing layers based on the measurements, and receive a phase-coherent joint transmission of a downlink message from the first set of TRPs in accordance with the first mapping, or from the second set of TRPs in accordance with the second mapping.

In some examples of the method, apparatuses, and non-transitory computer-readable medium described herein, the first CSI part includes a joint indication of a quantity of TRPs within each of the first set of TRPs and the second set of TRPs, and includes a corresponding joint rank indicator associated with each of the first set of TRPs and the second set of TRPs.

In some examples of the method, apparatuses, and non-transitory computer-readable medium described herein, the joint rank indicator includes a first rank indicator associated with the first set of TRPs and a second rank indicator associated with the second set of TRPs.

In some examples of the method, apparatuses, and non-transitory computer-readable medium described herein, the second CSI part includes an indication of TRPs included within the first set of TRPs, the second set of TRPs, or both.

In some examples of the method, apparatuses, and non-transitory computer-readable medium described herein, the indication of the TRPs includes a bitmap, a combination index, or both.

Some examples of the method, apparatuses, and non-transitory computer-readable medium described herein may further include operations, features, means, or instructions for receiving, via the control signaling, an indication of the first set of TRPs and the second set of TRPs, where an indication of the first mapping and the second mapping may be included in the first CSI part.

In some examples of the method, apparatuses, and non-transitory computer-readable medium described herein, the first set of TRPs may be mutually exclusive with respect to the second set of TRPs, where the second set of TRPs includes fewer TRPs than the first set of TRPs, and where the CSI report indicates a bitmap, a combination index, or both, which indicates TRPs included within the second set of TRPs.

In some examples of the method, apparatuses, and non-transitory computer-readable medium described herein, the second set of TRPs includes fewer TRPs than the first set of TRPs, where the CSI report includes an indication of at least one TRP that may be shared across the first set of TRPs and the second set of TRPs, and includes an indication of at least one additional TRP included in the second set of TRPs and which is not shared across the first set of TRPs and the second set of TRPs.

A method for wireless communication at a network entity is described. The method may include transmitting, to a UE, control signaling indicating a set of multiple TRPs and a set of measurement resources, transmitting a set of multiple reference signals via the set of multiple TRPs within the set of measurement resources, receiving, from the UE and based on the set of multiple reference signals, a CSI report including a first CSI part and a second CSI part, at least one of the first CSI part or the second CSI part indicating a first mapping between a first set of TRPs of the set of multiple TRPs and a first set of spatial multiplexing layers, and indicating a second mapping between a second set of TRPs of the set of multiple TRPs and a second set of spatial multiplexing layers, and transmitting, to the UE, a phase-coherent joint transmission of a downlink message from the first set of TRPs in accordance with the first mapping, or from the second set of TRPs in accordance with the second mapping.

An apparatus for wireless communication at a network entity is described. The apparatus may include a processor, memory coupled with the processor, and instructions stored in the memory. The instructions may be executable by the processor to cause the apparatus to transmit, to a UE, control signaling indicating a set of multiple TRPs and a set of measurement resources, transmit a set of multiple reference signals via the set of multiple TRPs within the set of measurement resources, receive, from the UE and based on the set of multiple reference signals, a CSI report including a first CSI part and a second CSI part, at least one of the first CSI part or the second CSI part indicating a first mapping between a first set of TRPs of the set of multiple TRPs and a first set of spatial multiplexing layers, and indicating a second mapping between a second set of TRPs of the set of multiple TRPs and a second set of spatial multiplexing layers, and transmit, to the UE, a phase-coherent joint transmission of a downlink message from the first set of TRPs in accordance with the first mapping, or from the second set of TRPs in accordance with the second mapping.

Another apparatus for wireless communication at a network entity is described. The apparatus may include means for transmitting, to a UE, control signaling indicating a set of multiple TRPs and a set of measurement resources, means for transmitting a set of multiple reference signals via the set of multiple TRPs within the set of measurement resources, means for receiving, from the UE and based on the set of multiple reference signals, a CSI report including a first CSI part and a second CSI part, at least one of the first CSI part or the second CSI part indicating a first mapping between a first set of TRPs of the set of multiple TRPs and a first set of spatial multiplexing layers, and indicating a second mapping between a second set of TRPs of the set of multiple TRPs and a second set of spatial multiplexing layers, and means for transmitting, to the UE, a phase-coherent joint transmission of a downlink message from the first set of TRPs in accordance with the first mapping, or from the second set of TRPs in accordance with the second mapping.

A non-transitory computer-readable medium storing code for wireless communication at a network entity is described. The code may include instructions executable by a processor to transmit, to a UE, control signaling indicating a set of multiple TRPs and a set of measurement resources, transmit a set of multiple reference signals via the set of multiple TRPs within the set of measurement resources, receive, from the UE and based on the set of multiple reference signals, a CSI report including a first CSI part and a second CSI part, at least one of the first CSI part or the second CSI part indicating a first mapping between a first set of TRPs of the set of multiple TRPs and a first set of spatial multiplexing layers, and indicating a second mapping between a second set of TRPs of the set of multiple TRPs and a second set of spatial multiplexing layers, and transmit, to the UE, a phase-coherent joint transmission of a downlink message from the first set of TRPs in accordance with the first mapping, or from the second set of TRPs in accordance with the second mapping.

In some examples of the method, apparatuses, and non-transitory computer-readable medium described herein, the first CSI part includes a joint indication of a quantity of TRPs within each of the first set of TRPs and the second set of TRPs, and includes a corresponding joint rank indicator associated with each of the first set of TRPs and the second set of TRPs.

In some examples of the method, apparatuses, and non-transitory computer-readable medium described herein, the joint rank indicator includes a first rank indicator associated with the first set of TRPs and a second rank indicator associated with the second set of TRPs.

In some examples of the method, apparatuses, and non-transitory computer-readable medium described herein, the second CSI part includes an indication of TRPs included within the first set of TRPs, the second set of TRPs, or both.

In some examples of the method, apparatuses, and non-transitory computer-readable medium described herein, the indication of the TRPs includes a bitmap, a combination index, or both.

Some examples of the method, apparatuses, and non-transitory computer-readable medium described herein may further include operations, features, means, or instructions for transmitting, via the control signaling, an indication of the first set of TRPs and the second set of TRPs, where an indication of the first mapping and the second mapping may be included in the first CSI part.

In some examples of the method, apparatuses, and non-transitory computer-readable medium described herein, the first set of TRPs may be mutually exclusive with respect to the second set of TRPs, where the second set of TRPs includes fewer TRPs than the first set of TRPs, and where the CSI report indicates a bitmap, a combination index, or both, which indicates TRPs included within the second set of TRPs.

In some examples of the method, apparatuses, and non-transitory computer-readable medium described herein, the second set of TRPs includes fewer TRPs than the first set of TRPs, where the CSI report includes an indication of at least one TRP that may be shared across the first set of TRPs and the second set of TRPs, and includes an indication of at least one additional TRP included in the second set of TRPs and which is not shared across the first set of TRPs and the second set of TRPs.

A method for wireless communication at a UE is described. The method may include receiving control signaling indicating a set of multiple transmission-configuration indicator (TCI) states corresponding to a set of multiple TRPs, the control signaling indicating a first TCI state group of the set of multiple TCI states corresponding to a first set of TRPs of the set of multiple TRPs, and indicating a second TCI state group of the set of multiple TCI states corresponding to a second set of TRPs of the set of multiple TRPs, receiving a first mapping between the first TCI state group and a first set of demodulation reference signal (DMRS) ports, a first set of spatial multiplexing layers, or both, and a second mapping between the second TCI state group and a second set of DMRS ports, a second set of spatial multiplexing layers, or both, and monitoring for a phase-coherent joint transmission of a downlink message from the first set of TRPs in accordance with the first mapping, or from the second set of TRPs in accordance with the second mapping.

An apparatus for wireless communication at a UE is described. The apparatus may include a processor, memory coupled with the processor, and instructions stored in the memory. The instructions may be executable by the processor to cause the apparatus to receive control signaling indicating a set of multiple TCI states corresponding to a set of multiple TRPs, the control signaling indicating a first TCI state group of the set of multiple TCI states corresponding to a first set of TRPs of the set of multiple TRPs, and indicating a second TCI state group of the set of multiple TCI states corresponding to a second set of TRPs of the set of multiple TRPs, receive a first mapping between the first TCI state group and a first set of DMRS ports, a first set of spatial multiplexing layers, or both, and a second mapping between the second TCI state group and a second set of DMRS ports, a second set of spatial multiplexing layers, or both, and monitor for a phase-coherent joint transmission of a downlink message from the first set of TRPs in accordance with the first mapping, or from the second set of TRPs in accordance with the second mapping.

Another apparatus for wireless communication at a UE is described. The apparatus may include means for receiving control signaling indicating a set of multiple TCI states corresponding to a set of multiple TRPs, the control signaling indicating a first TCI state group of the set of multiple TCI states corresponding to a first set of TRPs of the set of multiple TRPs, and indicating a second TCI state group of the set of multiple TCI states corresponding to a second set of TRPs of the set of multiple TRPs, means for receiving a first mapping between the first TCI state group and a first set of DMRS ports, a first set of spatial multiplexing layers, or both, and a second mapping between the second TCI state group and a second set of DMRS ports, a second set of spatial multiplexing layers, or both, and means for monitoring for a phase-coherent joint transmission of a downlink message from the first set of TRPs in accordance with the first mapping, or from the second set of TRPs in accordance with the second mapping.

A non-transitory computer-readable medium storing code for wireless communication at a UE is described. The code may include instructions executable by a processor to receive control signaling indicating a set of multiple TCI states corresponding to a set of multiple TRPs, the control signaling indicating a first TCI state group of the set of multiple TCI states corresponding to a first set of TRPs of the set of multiple TRPs, and indicating a second TCI state group of the set of multiple TCI states corresponding to a second set of TRPs of the set of multiple TRPs, receive a first mapping between the first TCI state group and a first set of DMRS ports, a first set of spatial multiplexing layers, or both, and a second mapping between the second TCI state group and a second set of DMRS ports, a second set of spatial multiplexing layers, or both, and monitor for a phase-coherent joint transmission of a downlink message from the first set of TRPs in accordance with the first mapping, or from the second set of TRPs in accordance with the second mapping.

In some examples of the method, apparatuses, and non-transitory computer-readable medium described herein, the control signaling indicates a third mapping between the first set of DMRS ports and the first set of spatial multiplexing layers, and indicates a fourth mapping between the second set of DMRS ports and the second set of spatial multiplexing layers, where the first mapping may be based on the third mapping, and where the second mapping may be based on the fourth mapping.

In some examples of the method, apparatuses, and non-transitory computer-readable medium described herein, the control signaling indicates a bitmap, a combination index, or both, that indicates TRPs included within the first set of TRPs, the second set of TRPs, or both.

In some examples of the method, apparatuses, and non-transitory computer-readable medium described herein, the control signaling indicates a bitmap, a combination index, or both, that indicates TCI states within the first TCI state group, the second TCI state group, or both.

In some examples of the method, apparatuses, and non-transitory computer-readable medium described herein, the control signaling includes radio resource control (RRC) signaling, downlink control information (DCI) signaling, or both.

In some examples of the method, apparatuses, and non-transitory computer-readable medium described herein, the first TCI state group may be mutually exclusive with respect to the second TCI state group, wherein the second transmission-configuration indicator state group includes fewer TCI states compared to the first transmission-configuration indicator state group, wherein the control signaling indicates a bitmap, a combination index, or both, which indicates TCI states included within the second TCI state group.

In some examples, the second transmission-configuration indicator state group includes fewer TCI states compared to the first transmission-configuration indicator state group, where the method, apparatuses, and non-transitory computer-readable medium described herein may further include operations, features, means, or instructions for receiving an indication of at least one TRP that may be shared across the first set of TRPs and the second set of TRPs, and an indication of at least one additional TRP that may be included in the second set of TRPs and which is not shared across the first set of TRPs and the second set of TRPs.

A method for wireless communication at a network entity is described. The method may include transmitting, to a UE, control signaling indicating a set of multiple TCI states corresponding to a set of multiple TRPs, the control signaling indicating a first TCI state group of the set of multiple TCI states corresponding to a first set of TRPs of the set of multiple TRPs, and indicating a second TCI state group of the set of multiple TCI states corresponding to a second set of TRPs of the set of multiple TRPs, transmitting, to the UE, a first mapping between the first TCI state group and a first set of DMRS ports, a first set of spatial multiplexing layers, or both, and a second mapping between the second TCI state group and a second set of DMRS ports, a second set of spatial multiplexing layers, or both, and transmitting a phase-coherent joint transmission of a downlink message from the first set of TRPs in accordance with the first mapping, or from the second set of TRPs in accordance with the second mapping.

An apparatus for wireless communication at a network entity is described. The apparatus may include a processor, memory coupled with the processor, and instructions stored in the memory. The instructions may be executable by the processor to cause the apparatus to transmit, to a UE, control signaling indicating a set of multiple TCI states corresponding to a set of multiple TRPs, the control signaling indicating a first TCI state group of the set of multiple TCI states corresponding to a first set of TRPs of the set of multiple TRPs, and indicating a second TCI state group of the set of multiple TCI states corresponding to a second set of TRPs of the set of multiple TRPs, transmit, to the UE, a first mapping between the first TCI state group and a first set of DMRS ports, a first set of spatial multiplexing layers, or both, and a second mapping between the second TCI state group and a second set of DMRS ports, a second set of spatial multiplexing layers, or both, and transmit a phase-coherent joint transmission of a downlink message from the first set of TRPs in accordance with the first mapping, or from the second set of TRPs in accordance with the second mapping.

Another apparatus for wireless communication at a network entity is described. The apparatus may include means for transmitting, to a UE, control signaling indicating a set of multiple TCI states corresponding to a set of multiple TRPs, the control signaling indicating a first TCI state group of the set of multiple TCI states corresponding to a first set of TRPs of the set of multiple TRPs, and indicating a second TCI state group of the set of multiple TCI states corresponding to a second set of TRPs of the set of multiple TRPs, means for transmitting, to the UE, a first mapping between the first TCI state group and a first set of DMRS ports, a first set of spatial multiplexing layers, or both, and a second mapping between the second TCI state group and a second set of DMRS ports, a second set of spatial multiplexing layers, or both, and means for transmitting a phase-coherent joint transmission of a downlink message from the first set of TRPs in accordance with the first mapping, or from the second set of TRPs in accordance with the second mapping.

A non-transitory computer-readable medium storing code for wireless communication at a network entity is described. The code may include instructions executable by a processor to transmit, to a UE, control signaling indicating a set of multiple TCI states corresponding to a set of multiple TRPs, the control signaling indicating a first TCI state group of the set of multiple TCI states corresponding to a first set of TRPs of the set of multiple TRPs, and indicating a second TCI state group of the set of multiple TCI states corresponding to a second set of TRPs of the set of multiple TRPs, transmit, to the UE, a first mapping between the first TCI state group and a first set of DMRS ports, a first set of spatial multiplexing layers, or both, and a second mapping between the second TCI state group and a second set of DMRS ports, a second set of spatial multiplexing layers, or both, and transmit a phase-coherent joint transmission of a downlink message from the first set of TRPs in accordance with the first mapping, or from the second set of TRPs in accordance with the second mapping.

In some examples of the method, apparatuses, and non-transitory computer-readable medium described herein, the control signaling indicates a third mapping between the first set of DMRS ports and the first set of spatial multiplexing layers, and indicates a fourth mapping between the second set of DMRS ports and the second set of spatial multiplexing layers, where the first mapping may be based on the third mapping, and where the second mapping may be based on the fourth mapping.

In some examples of the method, apparatuses, and non-transitory computer-readable medium described herein, the control signaling indicates a bitmap, a combination index, or both, that indicates TRPs included within the first set of TRPs, the second set of TRPs, or both.

In some examples of the method, apparatuses, and non-transitory computer-readable medium described herein, the control signaling indicates a bitmap, a combination index, or both, that indicates TCI states within the first TCI state group, the second TCI state group, or both.

In some examples of the method, apparatuses, and non-transitory computer-readable medium described herein, the control signaling includes RRC signaling, DCI signaling, or both.

In some examples of the method, apparatuses, and non-transitory computer-readable medium described herein, the first transmission-configuration indicator state group is mutually exclusive with respect to the second transmission-configuration indicator state group, where the second transmission-configuration indicator state group includes fewer TCI states compared to the first transmission-configuration indicator state group, where the control signaling indicates a bitmap, a combination index, or both, which indicates transmission-configuration indicator states included within the second transmission-configuration indicator state group.

In some examples the second transmission-configuration indicator state group includes fewer TCI states compared to the first transmission-configuration indicator state group, where the method, apparatuses, and non-transitory computer-readable medium described herein may further include operations, features, means, or instructions for transmitting an indication of at least one TRP that may be shared across the first set of TRPs and the second set of TRPs, and an indication of at least one additional TRP included in the second set of TRPs and which is not shared across the first set of TRPs and the second set of TRPs.

### BRIEF DESCRIPTION OF THE DRAWINGS

FIG. 1 illustrates an example of a wireless communications system that supports techniques for coherent joint transmission (CJT) across multiple transmission-reception point (TRP) sets in accordance with one or more aspects of the present disclosure.

FIG. 2 illustrates an example of a wireless communications system that supports techniques for CJT across multiple TRP sets in accordance with one or more aspects of the present disclosure.

FIG. 3 illustrates an example of a CJT reporting configuration that supports techniques for CJT across multiple TRP sets in accordance with one or more aspects of the present disclosure.

FIG. 4 illustrates an example of a transmission configuration indicator (TCI) state configuration that supports techniques for CJT across multiple TRP sets in accordance with one or more aspects of the present disclosure.

FIG. 5 illustrates an example of a process flow that supports techniques for CJT across multiple TRP sets in accordance with one or more aspects of the present disclosure.

FIG. 6 illustrates an example of a process flow that supports techniques for CJT across multiple TRP sets in accordance with one or more aspects of the present disclosure.

FIGS. 7 and 8 show block diagrams of devices that support techniques for CJT across multiple TRP sets in accordance with one or more aspects of the present disclosure.

FIG. 9 shows a block diagram of a communications manager that supports techniques for CJT across multiple TRP sets in accordance with one or more aspects of the present disclosure.

FIG. 10 shows a diagram of a system including a device that supports techniques for CJT across multiple TRP sets in accordance with one or more aspects of the present disclosure.

FIGS. 11 and 12 show block diagrams of devices that support techniques for CJT across multiple TRP sets in accordance with one or more aspects of the present disclosure.

FIG. 13 shows a block diagram of a communications manager that supports techniques for CJT across multiple TRP sets in accordance with one or more aspects of the present disclosure.

FIG. 14 shows a diagram of a system including a device that supports techniques for CJT across multiple TRP sets in accordance with one or more aspects of the present disclosure.

FIGS. 15 through 18 show flowcharts illustrating methods that support techniques for CJT across multiple TRP sets in accordance with one or more aspects of the present disclosure.

### DETAILED DESCRIPTION

Some wireless communications support coherent joint transmissions (CJTs) in which a message is transmitted coherently (e.g., with a same phase) across multiple transmission-reception points (TRPs). For example, a first TRP and a second TRP may transmit a same downlink message such that the downlink message exhibits phase coherency across both the respective TRPs. In some cases, the channel between a UE and the respective TRPs may be different (e.g., channel between UE and TRP1 may exhibit better performance than the channel between UE and TRP2). As such, the respective TRPs may support (or correspond to) differing numbers of spatial multiplexing layers (e.g., different ranks). However, when it comes to channel state information (CSI) reporting for multi-TRP (mTRP) CJTs with unrestricted layer-to-TRP mapping, reporting CSI information for multiple TRPs and multiple ranks/layers results in large CSI computational complexity at the UE, and large feedback overhead.

Accordingly, aspects of the present disclosure are directed to configurations, rules, and signaling that restrict TRP selection for mTRP CJT transmissions into defined sets of TRPs based on supported quantities of spatial multiplexing layers. In other words, aspects of the present disclosure enable TRPs to be grouped into respective TRP sets that support differing quantities of spatial multiplexing layers, where grouping of TRPs for CJTs may be determined by the network, or by the UE.

In the context of UE-selected TRP sets, the UE may receive control signaling from the network which indicates a set of TRPs that may be used for CJT, and may perform measurements on reference signals received from the respective TRPs. Based on the measurements, the UE may report mappings between sets of TRPs and corresponding sets of spatial multiplexing layers supported by the sets of TRPs. Subsequently, the UE may receive a CJT from one of the respective TRP sets in accordance with the reported layer-to-TRP mappings.

Such implementations of the subject matter described in this disclosure may be implemented to realize one or more of the following potential advantages. For example, enabling UEs to perform measurements on signals received from TRPs and to indicate mappings between sets of TRPs and supported quantities of spatial multiplexing layers may enable the network to perform mTRP CJTs in accordance with the indicated mappings. As such, aspects of the present disclosure may enable mTRP CJTs to be performed within sets of TRPs that support the same quantities of spatial multiplexing layers.

Comparatively, in the context of network-selected TRP sets, the network may indicate, to the UE, mappings between sets of TRPs and corresponding transmission-configuration indicator (TCI) state groups. Additionally, the network may indicate mappings between TCI state groups and sets of demodulation reference signal (DMRS) ports, sets of spatial multiplexing layers, or both. In this regard, by indicating the respective mappings to the UE, the UE may be configured to monitor for mTRP CJTs transmitted by the respective TRP sets in accordance with the mappings.

Such implementations of the subject matter described in this disclosure also can be implemented to realize one or more of the following potential advantages. For example, the network to select and indicate mappings between sets of TRPs and corresponding TCI state groups, as well as mappings between the TCI state groups and supported DMRS ports/spatial multiplexing layers, may enable the network to perform mTRP CJT transmissions using sets of TRPs that correspond to the same TCI state groups, and which support the same DMRS ports/spatial multiplexing layers. As such, aspects of the present disclosure may facilitate more efficient and widespread use of mTRP CJTs, which may improve coverage and average throughput within the network.

Aspects of the disclosure are initially described in the context of wireless communications systems. Additional aspects of the disclosure are described in the context of example CJT reporting configurations and an example process flow. Aspects of the disclosure are further illustrated by and described with reference to apparatus diagrams, system diagrams, and flowcharts that relate to techniques for CJT across multiple TRP sets.

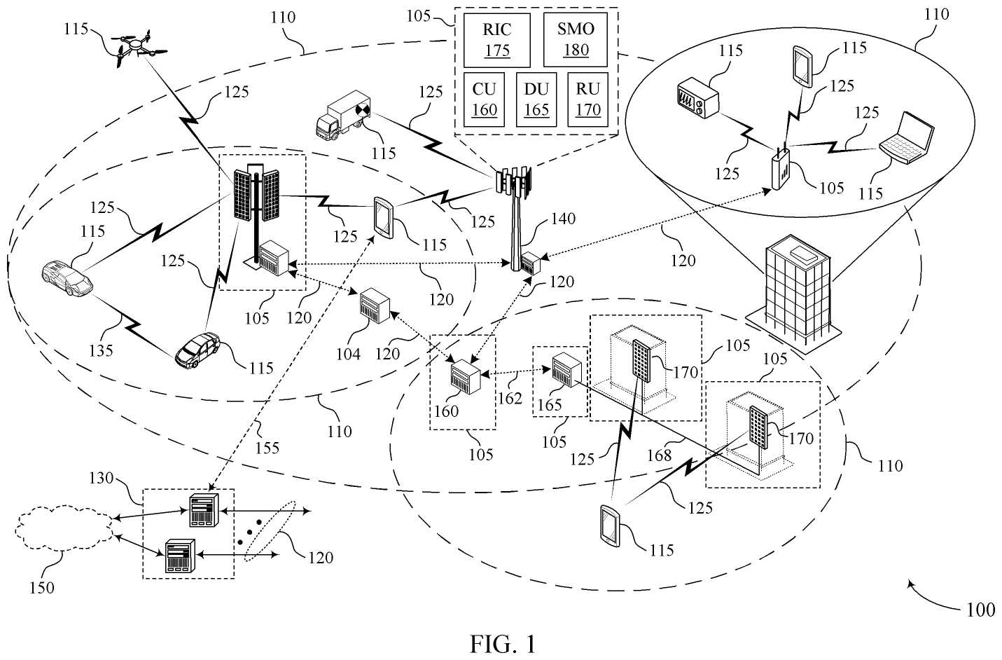

FIG. 1 illustrates an example of a wireless communications system 100 that supports techniques for CJT across multiple TRP sets in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for CJT across multiple TRP sets as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information (CSI) reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, UEs 115, network entities 105, and other wireless devices of the wireless communications system 100 may support configurations, rules, and signaling that restrict TRP selection for mTRP CJT transmissions into defined sets of TRPs based on supported quantities of spatial multiplexing layers. In other words, aspects of the present disclosure enable TRPs to be grouped into respective TRP sets that support differing quantities of spatial multiplexing layers, where grouping of TRPs for CJTs may be determined by the network, or by the UE.

In the context of UE-selected TRP sets, a UE 115 of the wireless communications system 100 may perform measurements on reference signals received from various TRPs of a network entity 105. Based on the measurements, the UE 115 may report mappings between sets of TRPs and corresponding sets of spatial multiplexing layers supported by the sets of TRPs (e.g., report TRP sets and corresponding rank). Subsequently, the UE 115 may receive a CJT from one of the respective TRP sets of the network entity 105 in accordance with the reported layer-to-TRP mappings. Comparatively, in the context of network-selected TRP sets, the network entity 105 may indicate, to the UE 115, mappings between sets of TRPs, TCI states, and DMRS groups (e.g., code-division multiplexing (CDM) groups) so that the UE 115 may monitor for CJTs transmitted by the respective TRP sets of the network entity 105 in accordance with the mappings.

Techniques described herein may enable TRPs to be grouped into sets that support the same quantities of spatial multiplexing layers, thereby facilitating more efficient and widespread use of mTRP CJTs, which may improve coverage and average throughput within the wireless communications system 100. Moreover, by grouping TRPs based on supported quantities of spatial multiplexing layers (e.g., by grouping TRPs based on rank), CSI reporting at UEs 115 in response to mTRP CJTs may be simplified. In particular, grouping TRPs by rank may reduce a CSI processing complexity at the UEs 115, and reduce a size of CSI reports, thereby reducing control signaling overhead and leading to a more efficient use of communication resources.

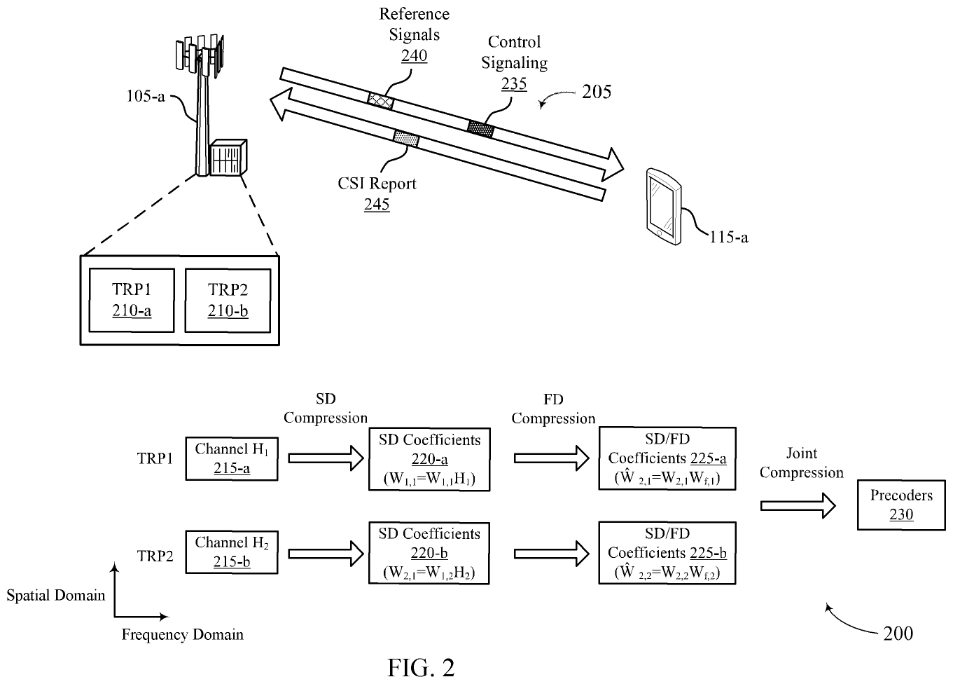

FIG. 2 illustrates an example of a wireless communications system 200 that supports techniques for CJT across multiple TRP sets in accordance with one or more aspects of the present disclosure. In some examples, aspects of the wireless communications system 200 may implement, or be implemented by, aspects of the wireless communications system 100. In particular, the wireless communications system 200 may support techniques that enable mTRP CJTs, as described with respect to FIG. 1.

The wireless communications system 200 may include a network entity 105-a and a UE 115-a. The UE 115-a may communicate with the network entity 105-a using a communication link 205, which may be an example of an NR or LTE link between the respective UE 115-a and the network entity 105-a. In some cases, the communication link 205 may include an example of an access link (e.g., Uu links) which may include a bi-directional link that enables both uplink and downlink communication. For example, the UE 115-a may transmit uplink signals, such as uplink control signals or uplink data signals, to one or more components of the network entity 105-a using the communication link 205, and one or more components of the network entity 105-a may transmit downlink signals, such as downlink control signals or downlink data signals, to the UE 115-a using the communication link 205.

In some aspects, the network entity 105-a may include or be associated with multiple TRPs. For example, as shown in FIG. 2, the network entity 105-a may include a first TRP 210-a and a second TRP 210-b. Each respective TRP 210 may be configured to perform wireless communications independently from one another, and/or in conjunction with one another.

For example, as noted previously herein, some wireless communications systems may support CJTs across multiple TRPs 210 (mTRPs). For example, the first TRP 210-a and the second TRP 210-b may each transmit a same message (e.g., same payload or signal) such that the respective messages/signals transmitted by the respective TRPs 210 exhibit phase coherency (e.g., the same phase) with one another. CJTs across mTRPs 210 may improve coverage and average throughput with high performance backhaul and synchronization within the wireless communications system 200.

In the context of Type II codebook refinement for mTRP CJTs, the UE 115-a and/or the network entity 105-a may perform spatial domain and/or frequency domain basis selection. Spatial domain/frequency domain basis selection may be performed to determine whether mTRP 210 CJTs are to be performed per-TRP/TRP group (e.g., separately), or across all TRPs 210/TRP groups (e.g., jointly) of the network entity 105-a. Inter-TRP 210 co-phasing/amplitude may also be determined for separate spatial domain and frequency domain basis selection. In some cases, the UE 115-a may report the number of non-zero coefficients (e.g., bitmap indicating non-zero coefficients) jointly or separately for the different TRPs 210. The strongest coefficient indicator (SCI) may be indicated one per TRP 210/TRP group, or commonly for all TRPs 210.

For example, FIG. 2 illustrates an example eType-II CSI reporting configuration in which spatial domain and frequency domain compression are performed via linear combination of direct Fourier transform (DFT) bases. As illustrated in FIG. 2, the UE 115-a may perform channel estimation on signals received from each of the TRPs 210. For instance, the UE 115-a may estimate a first channel 215-a (H₁) between the UE 115-a and the first TRP 210-a, and a second channel 215-b (H₂) between the UE 115-a and the second TRP 210-b. For Type-II CSI reporting for CJT, precoders for a layer l (e.g., spatial multiplexing layer) across N₃ precoding matrix indicator (PMI) subbands may be given by size Nₜ×N₃ matrices represented by Equation 1 below:

$${W}^{( l )} = {W}_{1} {\tilde{W}}_{2 , l} {W}_{f , l}^{H} \qquad ( 1 )$$

where W₁ represents spatial-domain bases (DFT bases),

$${W}_{f , l}^{H}$$

represents frequency-domain bases (DFT bases), and \tilde{W}_{2,l} represent precoder coefficients. In this regard, the respective channels 215 may be represented by Nₜ×N₃ matrices, where Nₜ is the number of transmission antenna ports per TRP.

In order to determine precoders 230 that are to be used for the respective channels 215 (e.g., by the respective TRPs 210) for mTRP CJTs, the UE 115-a may perform spatial-domain compression on the respective channels 215-a, 215-b to determine respective sets of spatial-domain coefficients 220-a, 220-b. In some cases, the UE 115-a may perform spatial-domain compression on the respective channels 215 using compression matrices W_{1,1}:Nₜ×2L and W_{1,2}:Nₜ×2L, respectively. The first set of spatial-domain coefficients 220-a associated with the first TRP 210-a may be represented by

$${W}_{2 , 1} = {W}_{1 , 1}^{H} {H}_{1} ,$$

and the second ser un spatial-domain coefficients 220-b associated with the second TRP 210-b may be represented by

$${W}_{2 , 2} = {W}_{1 , 2}^{H} {H}_{2} .$$

Additionally, the UE 115-a may perform frequency-domain compression on to determine respective sets of spatial/frequency-domain (SD, FD) coefficients 225-a, 225-b. In some cases, the UE 115-a may perform spatial/frequency-domain compression using compression matrices W_{f,1}:N₃×M and W_{f,2}:N₃×M, respectively. The first set of spatial/frequency-domain coefficients 225-a associated with the first TRP 210-a may be represented by \tilde{W}_{2,1}=W_{2,1}W_{f,1}, and the second set of spatial/frequency-domain coefficients 225-b associated with the second TRP 210-b may be represented by \tilde{W}_{2,2}=W_{2,2}W_{f,2}. In some aspects, the respective spatial/frequency-domain coefficients 225-a and 225-b may exhibit co-amplitude/phase.

Subsequently, the UE 115-a may perform joint coefficient compression on the respective spatial/frequency-domain coefficients 225 to determine a set of precoders 230 for the respective TRPs 210 that will be reported back to the network entity 105-a. In particular, when performing joint coefficient compression, the UE 115-a may select strong coefficients and set weak coefficients to zero in order to determine precoder(s) 230, which may be represented by Equation 2 below:

$$P = [ \begin{matrix}{P}_{1} \\ {qP}_{2}\end{matrix} ] = [ \begin{matrix}{W}_{1 , 1} & {\tilde{W}}_{2 , 1} & {W}_{f , 1}^{H} \\ {qW}_{1 , 2} & {\tilde{W}}_{2 , 2} & {W}_{f , 2}^{H}\end{matrix} ] \qquad ( 2 )$$

The spatial-domain bases W₁ may be layer-common in which the UE 115-a selects L beams (where L is RRC configured). Comparatively, the frequency-domain bases

$${W}_{f , l}^{H}$$

may be layer-specific, where the UE 115-a selects M bases out of N₃ bases and reports the selection for each layer. For each layer, the UE 115-a may report up to K₀ coefficients (e.g., \tilde{W}_{2,l}), where Ko may be RRC configured. Across all layers, the UE 115-a may report up to 2K₀ non-zero coefficients, where unreported coefficients are set to zeros. Moreover, the UE 115-a may be configured to report coefficient selection (e.g., the location of NZCs within \tilde{W}_{2,l}) and the quantization of the NZCs for each layer.

In some wireless communications systems, when performing TRP 210 selection for mTRP CJT for Type-II codebook refinement, wireless devices may be configured to down-select from various TRP 210 selection or determination implementations (where N is the number of cooperating TRPs 210 in precoding matrix indicator (PMI) reporting). In accordance with a first implementation for TRP 210 selection for mTRP CJT, the quantity of TRPs 210 N may be configured by the network via higher-layer signaling, such as RRC signaling. In this implementation, the UE 115-a may be configured to report a single transmission hypothesis.

In accordance with a second implementation for TRP 210 selection for mTRP CJT, the quantity of TRPs 210 N may be selected by the UE 115-a and reported as part of a CSI report for N∈{1, . . . , N_{TRP}}, where N is the number of cooperating TRPs 210 and where N_{TRP} is the maximum number of cooperating TRPs 210 configured by the network (e.g., configured by the network entity 105-a). In this case, the selection of N out of N_{TRP} quantity of TRPs 210 may be reported by the UE 115-a to the network. In accordance with a second implementation for TRP 210 selection for mTRP CJT, the UE 115-a may be configured to report CSI corresponding to K transmission hypotheses. In this implementation, the N configured TRPs 210 associated with one transmission hypothesis may be configured by the network via higher-layer signaling (e.g., RRC signaling).

However, there are several shortfalls associated with current TRP 210 selection techniques for mTRP CJT. For example, current TRP 210 selection techniques for mTRP CJT do not preclude layer-specific TRP 210 selection for mTRP CJT. In this regard, channel ranks associated with each TRP 210 may be different from one another. In other words, a CJT may be performed across the first TRP 210-a and the second TRP 210-b despite the TRPs 210 being associated with (e.g., supporting) different quantities of spatial multiplexing layers (e.g., despite the TRPs 210 being associated with different ranks.

To address layer-specific TRP 210 selection for mTRP CJT, some wireless communications systems may enable some layers (e.g., spatial multiplexing layers) to be transmitted from all the TRPs 210, while other layers may be transmitted from a subset of the TRPs 210. In other words, some wireless communications systems may enable hybrid CJT and non-CJT transmission. For example, based on a hybrid scheme TRP 210-a {A, B} may perform CJT for layer 1 and 2, and TRP 210-b {C, D} may perform CJT for layer 3 and 4, where non-CJT is applied across the respective two sets of layers (e.g., non-CJT between {A, B} and {C, D}).

However, layer-specific TRP 210 selection without restriction may significantly increase CSI computation complexity and feedback overhead at the UE 115-a. For example, assuming four TRPs 210 and rank 4, the number of transmission hypotheses may be 4⁴=256 since the cooperated TRPs for each layer can be different varying from one to up to four TRPs. In other words, in this example, the UE 115-a may be expected to report 256 different transmission hypotheses As such, reporting TRP-specific rank and the mapping of TRPs 210 to layers may result in significant signaling overhead.

Additionally, layer-specific TRP 210 selection without restriction may impact TCI state configuration and indication in DCI signaling. In particular, in some wireless communications systems, a TCI field in a DCI message may point to one or two TCI states, with each TCI state providing a quasi co-location (QCL) reference downlink reference signal (DL-RS) of the TCI state for the associated PDSCH demodulation reference signal (DMRS) port(s). As such, layer-specific TRP 210 selection may require a layer-specific mapping of TCI states to DMRS ports. Assuming N TRPs 210 and L layers, the mapping indication may require a total N*L bits, with N bits for each layer, where a bit value of ‘1’ indicates the corresponding TCI state (or TRP 210) is associated with the respective layer.

Accordingly, aspects of the present disclosure are directed to techniques for restricting TRP selection for mTRP CJT in order to balance competing interests between performance and UE 115 complexity. In other words, aspects of the present disclosure may enable the UE 115-a and/or the network entity 105-a to select sets of TRPs 210 based on the rank/quantity of supported spatial multiplexing layers (e.g., first set of TRPs 210 supports rank X, second set of TRPs 210 supports rank Y). In accordance with some aspects of the present disclosure, joint TRP set selection across layers is considered, where the number of TRP set selection across layers is no larger than two (e.g., maximum two sets of layers for each respective TRP set). In some aspects, the number of TRPs 210 within each set may be rank dependent (e.g., single TRP set for rank indicator (RI)≤2, and maximum two TRP 210 sets for RI>2.

In accordance with some aspects of the present disclosure, two separate sets of TRPs 210 may be configured by the network via higher-layer signaling (e.g., RRC signaling), or selected and reported by the UE 115-a as a part of a CSI report. In other words, aspects of the present disclosure are directed to multiple different approaches for selecting TRP 210 sets for mTRP CJT, including (1) a gNB-based approach, and (2) a UE-based approach.

For the gNB-based approach, TRP sets may configured via two channel measurement resources (CMRs) within the same CSI-RS resource set or two separate CSI-RS source sets configuration. In such cases, the UE 115-a may be expected to report the TRP set selection for each layer (e.g., indicate mappings of the TRP sets to the respective layers).

For the UE-based approach for selecting TRP 210 sets for mTRP CJT, N_{TRP} cooperating TRPs 210 may be configured by the network entity 105-a via N_{TRP} CSI-RS resources, and the selection of TRPs 210 out of the N_{TRP} TRPs 210 for each of the two sets of TRPs 210 may be reported by the UE 115-a. Additionally, the UE 115-a may be expected to report the TRP set selection for each layer (e.g., the mapping of the TRP sets to the respective layers). For both approaches, the two sets of TRPs 210 for CJT may be configured as full-overlapping, non-overlapping or partial overlapping (e.g., the respective sets of TRPs 210 may have different TRPs 210, or TRPs 210 may be included within both sets). The different overlapping configurations across the sets of TRPs 210 may impact the feedback design, as will be described in further detail herein.

Each of the respective approaches for selecting TRP 210 sets for mTRP CJT (e.g., UE-based approach and the gNB-based approach) will be described in further detail herein.

In the context of the UE-based approach, the UE 115-a may receive control signaling 235 (e.g., RRC signaling) indicating a set of TRPs 210 (e.g., TRP 210-a, 210-b, additional TRPs 210) and a set of measurement resources. In other words, the TRP 210 set may be gNB-configured. In this example, the UE 115-a may receive reference signals 240 transmitted by the respective TRPs 210 of the network entity 105-a within the set of measurement resources, and may report (e.g., via a CSI report 245 or other control signaling) a mapping of TRP sets to layers via a bitmap of length equal to the reported rank. In other words, the UE 115-a may perform measurements on the received reference signals 240, determine a rank associated with each respective TRP 210, and may report mappings between sets of TRPs 210 and sets of spatial multiplexing layers (e.g., {TRP set 1, rank 1}, {TRP set 2, rank 2}. In this example, bit ‘0’ indicates TRP set 0 is associated with the corresponding layer, and bit ‘1’ indicates TRP set 1. In some cases, a bitmap with all zero (or ones) is possible (e.g., a common TRP set used for all the layers).

Continuing with the example of the UE-selected TRP 210 sets, the UE 115-a may be configured to implement two-stage reporting (e.g., two-stage CSI reporting). In a first stage (e.g., the first CSI part or CSI part 1), the UE 115-a may report a joint indication of a number of TRPs 210 in each set based on a predefined look-up table, as well as the RI for the two respective TRP sets. In other words, in the first stage, the UE 115-a may indicate that a first TRP set includes X TRPs 210 associated with a first RI, and that a second TRP set includes Y TRPs 210 associated with a second RI. In some cases, the predefined look-up table may be dependent on a type of TRP set, and may use N_{TRP} as an input (e.g., look up table may be referenced by N_{TRP}) where N_{TRP} is the number of cooperating TRPs 210 configured by the network. The two RIs for the two respective TRP sets may be reported by a joint RI index corresponding to one of the four rank combinations (e.g., {1,1}, {1,2}, {2,1}, {2,2}).

In a second stage of the two-stage CSI reporting (e.g., the second CSI part or CSI part 2), the UE 115-a may indicate the TRP selection in each TRP set and the mapping to the layers. In other words, the UE 115-a may indicate which TRPs 210 are included within each of the respective TRP sets. Additionally, the UE 115-a may indicate a mapping to the supported spatial multiplexing layers for the respective TRPs 210. For full or non-overlapping TRP sets (e.g., TRP sets with the same TRPs 210, or TRP sets that do not include any TRPs 210 that are included in both sets), a single indication (e.g., bitmap or combination index) may be used to indicate TRPs 210 in the TRP set with the smaller size. Comparatively, for partially overlapping TRP sets (e.g., TRP sets that include at least one common TRP 210 that is included in both TRP sets), a first indication may be used to indicate common TRPs 210 within two sets, and a second indication may be used to indicate the non-overlapping TRPs 210 in the TRP set with the smaller size.

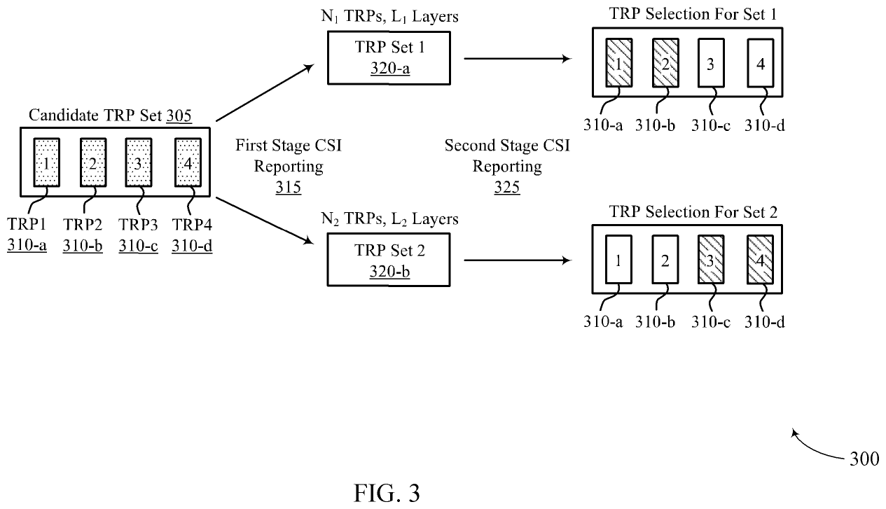

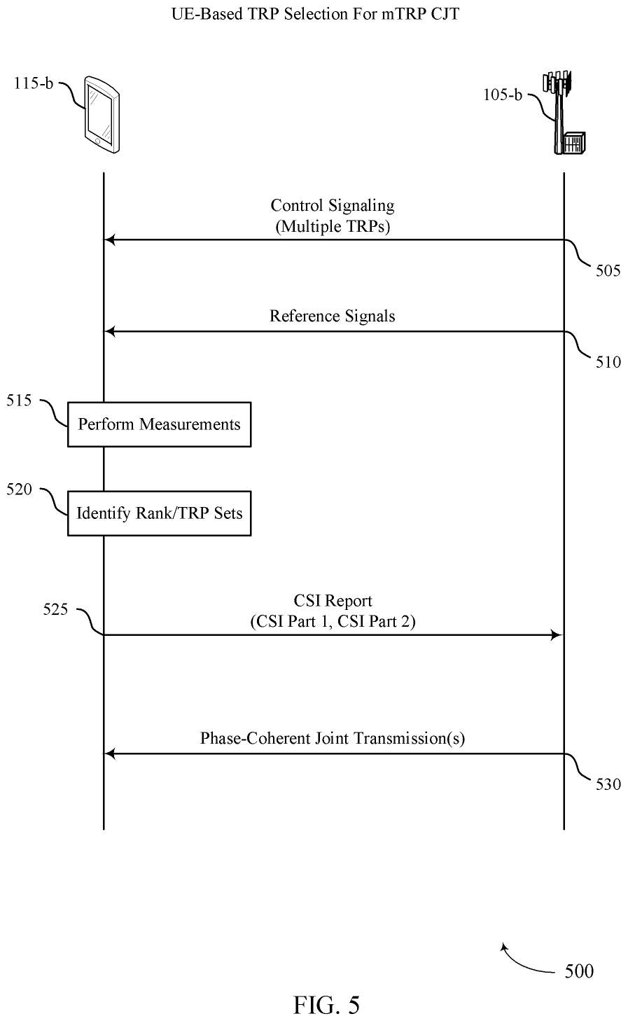

The UE-based approach in which the UE 115-a selects and indicates the TRPs 210 included in the respective sets of TRPs 210 for mTRP CJT may be further shown and described with reference to FIGS. 3 and 5.

FIG. 3 illustrates an example of a CJT reporting configuration 300 that supports techniques for CJT across multiple TRP sets in accordance with one or more aspects of the present disclosure. In some examples, aspects of the CJT reporting configuration 300 may implement, or be implemented by, aspects of the wireless communications system 100, the wireless communications system 200, or both. In particular, the CJT reporting configuration 300 illustrates a UE-based approach for selecting and indicating TRPs included within respective TRP sets for mTRP CJT, as described with respect to FIG. 1-2.

As shown in FIG. 3, the network may configure a candidate TRP set 305 including multiple TRPs 310. In this example, the candidate TRP set 305 may include a first TRP 310-a, a second TRP 310-b, a third TRP 310-c, and a fourth TRP 310-d. The respective TRPs 310 may be supported by (e.g., associated with) the same network entity 105 or multiple network entities 105.

As described previously herein, a UE 115 may receive reference signals transmitted by the respective TRPs 310, and may perform measurements on the received reference signals. In performing the measurements, the UE 115 may determine quantities (or sets) of spatial multiplexing layers supported by each respective TRP 310. In other words, the UE 115 may determine a rank associated with each respective TRP 310, and may group the candidate TRP set 305 into two separate TRP sets 320 based on the rank/supported spatial multiplexing layers of each respective TRP 310.

In some aspects, the UE 115 may then perform a two-stage CSI reporting procedure (e.g., two-stage CSI reporting configuration) to indicate mappings between the TRPs 310, the TRP sets 320, and supported spatial multiplexing layers (e.g., rank). In a first stage 315 of the two-stage CSI reporting procedure/configuration, the UE 115 may report a joint indication of a number of TRPs 310 in each TRP set 320, as well as the RI for the two respective TRP sets 320. For instance, as shown in FIG. 3, the UE 115 may indicate a first quantity of TRPs 310 (N₁) and a first RI (L₁) associated with the first TRP set 320-a. Similarly, the UE 115 may indicate a second quantity of TRPs 310 (N₂) and a second RI (L₂) associated with the second TRP set 320-b.

In a second stage 325 of the two-stage CSI reporting procedure/configuration, the UE 115 may indicate the TRP selection in each TRP set 320 and the mapping to the layers, such as via a bitmap or combination index. In other words, the UE 115 may indicate which TRPs 310 are included within each of the respective TRP sets 320. For instance, as shown in FIG. 3, the UE 115 may indicate that the first TRP 310-a and the second TRP 310-b are included within the first TRP set 320-a, and may indicate that the third TRP 310-c and the fourth TRP 310-d are included within the second TRP set 320-b.

An example of a joint indication for the number of TRPs 310 in each TRP set 320 for UE-based TRP set 320 selection is shown in Table 1 below for N_{TRP} less than or equal to four. However, it is noted herein that joint indications TRPs 310 in each TRP set 320 may be extended to other N_{TRP} values.

TABLE 1
Second Stage CSI Reporting

| N_{TRP} | Full- | Non- | Partial- |
|---|---|---|---|
| (No. of | Overlapping | Overlapping | Overlapping |
| TRPs) | TRP Sets | TRP Sets | TRP Sets |
| 4 | (4, 1), (4, 2), (4, 3), (4, 4) | (3, 1), (2, 2) | (2, 1, 1) or (3, 2) |
| | | | (1, 2, 1) or (3, 3) |
| 3 | (3, 1), (3, 2), (3, 3) | (1, 2) | (1, 1, 1) or (2, 2) |
| 2 | (2, 1), (2, 2) | (1, 1) | — |

The example joint indication for the number of TRPs 310 in each TRP set 320 shown in Table 1 below above is for N_{TRP} less than or equal to four. However, it is noted herein that joint indications TRPs 310 in each TRP set 320 may be extended to other N_{TRP} values. For the partial-overlapping case, the number of common TRPs 310 in both TRP sets 320 may be explicitly indicated or implicitly derived by N₁+N₂-N_{TRP}, where N₁ and N₂ define the size of the first TRP set 320-a and the second TRP set 320-b, respectively.

As noted previously herein, the reporting (and the complexity of the reporting) for the second stage 325 may be dependent on whether the TRP sets 320 are full-overlapping, non-overlapping, or partial-overlapping. The terms “full-overlapping,” “non-overlapping,” and “partial-overlapping” may be used to refer to a quantity of “common” TRPs 310 that are shared across the TRP sets 320. Full-overlapping TRP sets 320 may occur when all TRPs 310 of one TRP set 320 are included in the other TRP set 320 (e.g., one TRP set 320 contains all the cooperating TRPs 310 configured by the network entity 105-a, and the other TRP set 320 includes only a subset of the cooperating TRPs 310). For instance, a TRP Set 1 with TRPs 310 {1, 2, 3, and 4} and a TRP Set 2 with TRPs 310 {1, 2} would include “full-overlapping” TRP sets 320. Non-overlapping TRP sets 320 do not include any common TRPs 310 (e.g., no TRPs 310 are included within both TRP sets 320). Partial-overlapping TRP sets 320 include one or more common TRPs 310 that are shared across both TRP sets 320, and one or more TRPs 310 that are not shared across both TRP sets 320.

In the context of the full-overlapping TRP sets 320, at least one of the TRP sets 320 will include all N_{TRP} TRPs 310, and the indication in the second stage 325 may indicate only the TRP set 320 with the smaller quantity of TRPs 310. Moreover, for the full-overlapping and the non-overlapping TRP sets 320, in cases where the UE 115-a indicates the TRPs 310 within each TRP set 320 via a bitmap, the bitmap may have a length of N_{TRP} (N_{TRP}=4 in FIG. 3), where the bitmap values indicate whether the corresponding TRP 310 belongs to the TRP sets 320 with the smaller quantity of TRPs 310 (e.g., for the non-overlapping TRP sets 320, bitmap [1 1 0 0] indicates that the first TRP 310-a and the second TRP 310-b belong to the first TRP set 320-a.) Comparatively, in cases where a combination index is used for the full-overlapping and the non-overlapping TRP sets 320, the combination index indicator may have a size of

$$[ {log}_{2} ( \begin{matrix}{N}_{TRP} \\ N\end{matrix} ) ] ,$$

where N is the size of the TRP set 320 of smaller size which was reported in the first stage 315 for CSI reporting.

In the context of partial-overlapping TRP sets 320, if the UE 115 uses a bitmap to indicate TRPs 310 within each TRP set 320, a first indicator may have a length of N_{TRP}, and the second indicator may have a size equal to the number of non-overlapping TRPs 310 in the two TRP sets 320. Comparatively, if a combination index is used to indicate TRPs 310 in each TRP set 320, the first and second indicators may be jointly encoded with a size of

$$[ {log}_{2} ( \begin{matrix}{N}_{TRP} \\ N\end{matrix} ) ( \begin{matrix}{N}_{TRP} - M \\ N - M\end{matrix} ) ] ,$$

where N is the size of the TRP set 320 of smaller quantity which was reported in the first stage 315 for CSI reporting and M is the number of overlapping TRPs 310 (e.g., common TRPs 310) in both TRP sets 320. In some cases, a bitmap may result in more efficient reporting for the full/non-overlapping cases, where a combination index may save overhead and therefore result in more efficient reporting for the partial-overlapping case.

Reference will again be made to the wireless communications system 200 illustrated in FIG. 2.

In additional or alternative implementations, the wireless communications system 200 may implement a gNB-based approach for selecting TRP 210 sets for mTRP CJT. In such cases, the network entity 105-a may utilize TCI state configuration and indications for CJT with two TRP sets.

For example, in the context of gNB-based TRP 210 selection for mTRP CJT, the network entity 105-a may configure a mapping of a single TCI codepoint to a set of multiple of TCI states (e.g., up to four) via the control signaling 235 (e.g., higher layer signaling, such as RRC signaling). In this example, each TCI state may represent one TRP 210. As such, the UE 115-a may be configured to derive the number of cooperating TRPs 210 (e.g., N_{TRP}) for mTRP CJT based on TCI field indication in the control signaling 235 or other control signaling (e.g., DCI).

Continuing with the same example, the network entity 105-a may include an additional indicator to the DCI to indicate how the indicated TCI states are grouped into two sets (corresponding to TRP 210 sets) and the size of the TRP 210 sets. That is, the network entity 105-a may indicate a mapping between the sets of TRPs 210 and the corresponding TCI states, and the quantity of TRPs 210 included within each set. Moreover, as described previously herein with indicating TRP set selection via the CSI report 245, similar techniques may be used for indicating full-overlapping, non-overlapping, and partial-overlapping TRP sets (e.g., using a bitmap for full or non-overlapping TRP sets, and a combination index for partial-overlapping TRP sets).

In some aspects, the size of the TCI state grouping indicator may be based on a maximum value of N_{TRP} (e.g., 4), where zero padding is used if N_{TRP}<4. That is, the TCI state grouping indicator may include four bits for full/non-overlapping cases, and five bits for partial-overlapping cases. Lastly, since DMRS ports of two TRP sets belong to two different CDM groups, one more bit may be included within the DCI/control signaling 235 to indicate the association of CDM groups to two TRP sets or two TCI state groups (e.g., extra bit indicates whether CDM group 0 is associated with TRP set 0 or TRP set 1).

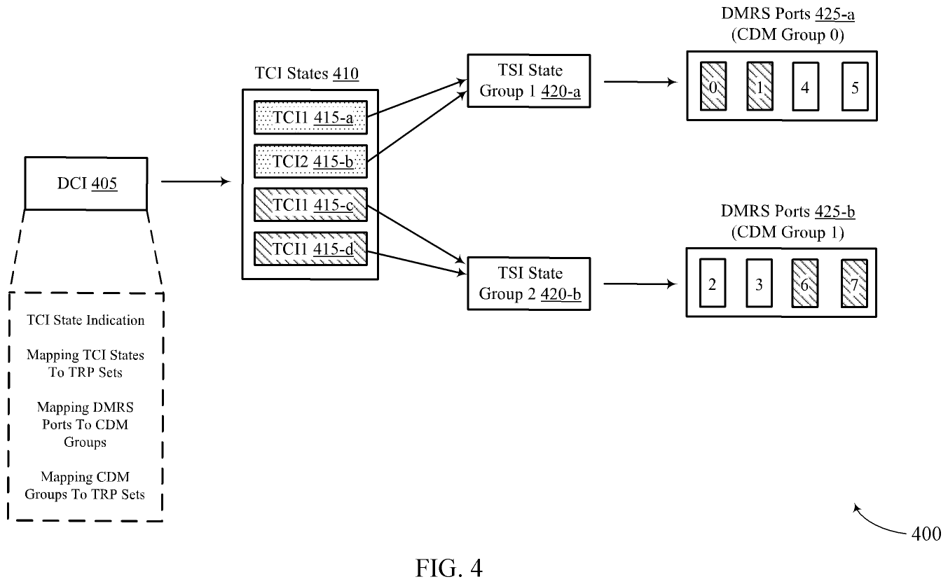

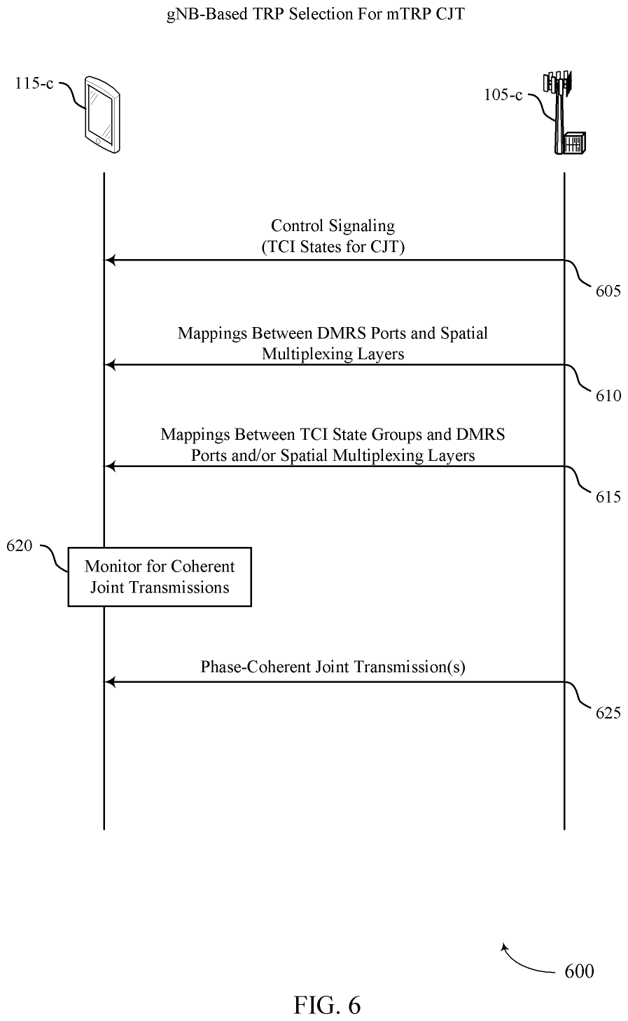

The gNB-based approach in which the network entity 105-a selects and indicates the TRPs 210 included in the respective sets of TRPs 210 for mTRP CJT may be further shown and described with reference to FIGS. 4 and 6.

FIG. 4 illustrates an example of TCI state configuration and indication 400 that supports techniques for CJT across multiple TRP sets in accordance with one or more aspects of the present disclosure. In some examples, aspects of the CJT TCI state configuration and indication 400 may implement, or be implemented by, aspects of the wireless communications system 100, the wireless communications system 200, or both. In particular, the CJT TCI state configuration and indication 400 illustrates a gNB-based approach for selecting and indicating TRPs included within respective TRP sets for mTRP CJT, as described with respect to FIG. 1-2.

As shown in FIG. 4, a UE 115 may receive a DCI 405 (and/or other control signaling) from a network entity 105 that indicates information associated with CJT transmissions between the UE 115 and the network. The DCI 405 may include a TCI state indication associated with a set of TCI states 410. For example, the DCI 405 may indicate a set of TCI states 410 including a first TCI state 415-a, a second TCI state 415-b, a third TCI state 415-c, and a fourth TCI state 415-d. In this regard, the DCI 405 in FIG. 4 may indicate four separate TCI states 415 for CJT across four TRPs. In some cases, the indicated TCI states 415 may be associated with a scheduled downlink message (e.g., PDSCH message) between the network entity 105 and the UE 115.

In some cases, the network entity 105 may configure a mapping of a single TCI codepoint to a set of multiple of TCI states 415 (e.g., up to four) via DCI 405 or other control signaling (e.g., RRC). In this example, each TCI state 415 may represent one TRP. For example, the first TCI state 415-a may be associated with (e.g., represent) a first TRP, the second TCI state 415-b may be associated with a second TRP, etc. As such, the UE 115 may be configured to derive the number of cooperating TRPs (e.g., N_{TRP}) for mTRP CJT based on TCI field indication in the DCI 405.

In some cases, the DCI 405 (or other control signaling) may include an additional indicator (e.g., bitmap, combination index, or both) which indicates how the set of TCI states 410 are divided into two different TCI state groups 420-a, 420-b. groups or sets. For example, the DCI 405 may indicate mappings between TCI states 415 and corresponding TCI state groups 420. For example, as shown in FIG. 2, the DCI 405 may include a bitmap [0, 0, 1, 1] (for a non-overlapping case) indicating the first and second TCI states 415-a, 415-b are associated with the first TCI group 420-a, and the third and fourth TCI states 415-c, 415-d are associated with the second TCI group 420-b.

As noted previously herein, how the mappings between the TCI states 415 and the TCI state groups 420 may be based on whether the TCI state groups 420 are full-overlapping, non-overlapping, or partial-overlapping. For example, the indication of the mapping may use a single indicator (four bits) for full and non-overlapping cases, and may use two indicators (five bits) for partial-overlapping cases. Mappings for different types of TRP sets (e.g., full-overlapping, non-overlapping, and partial-overlapping) are further shown and described in Table 2 below:

TABLE 2
Mappings for TRP Sets

| Type of | | Examples |
|---|---|---|
| TRP Sets | Indicators | (for N_{TRP} = 4) |
| Full | N_{TRP}-bits bitmap where the bit value | “1100” indicates |
| over- | indicates whether the corresponding TRP | TRP set 0 (subset) |
| lapping | belongs to the TRP set with the smaller | contains TRP 0 |
| two TRP | quantity of TRPs | and 1, and TRP |
| sets | | set 1 (full set) |
| | | contains TRP |
| | | 0, 1, 2 and 3 |
| Non- | N_{TRP}-bits bitmap where the bit value | “0010” indicates |
| over- | indicates whether the corresponding TRP | TRP set 0 contains |
| lapping | belongs to the TRP set with the smaller | TRP 2, and |
| two TRP | quantity of TRPs | TRP set 1 contains |
| sets | | TRP 0, 1, and 3 |
| Partial | Joint coded first and second | M is 1 or 2 for |
| over- | indicator (i₁, i₂) | N_{TRP} = 4 |
| lapping two TRP | $with a size of ⌈ {log}_{2} ( \begin{matrix}{N}_{TRP} \\ M\end{matrix} ) ( \begin{matrix}{N}_{TRP} - M \\ N - M\end{matrix} ) ⌉$ | (i₁, i₂) = 0 . . . 11 indicates two TRP |
| sets | where M is the number of overlapping | sets have one |
| | TRPs in both TRP sets. | overlapping TRP. |
| | | (i₁, i₂) = 12 . . . 23 |
| | | indicates two TRP |
| | | sets have two |
| | | overlapping TRPs. |

In some aspects, the DCI 405 may indicate mappings between sets of DMRS ports 425 and CDM groups, and/or mappings between DMRS ports and associated spatial multiplexing layers. For example, the DCI 405 may indicate a first mapping or association between a first set of DMRS ports 425-a and a first set of spatial multiplexing layers, and a second mapping/association between a second set of DMRS ports 425-b and a second set of spatial multiplexing layers. Additionally, or alternatively, the DCI 405 may indicate associations between sets of DMRS ports 425 and corresponding CDM groups (e.g., DMRS port {0, 2, 3} for RI=3 indicating port 0 in CDM group 0 and ports {2, 3} in CDM group 1).

Additionally, the DCI 405 may indicate a fourth indicator which maps TCI state groups 420-a, 420-b to corresponding sets of DMRS port 425 (or layers). That is, the DCI 405 may indicate a first mapping or association between the first TCI state group 420-a and the first set of DMRS ports 425-a (or the first set of associated spatial multiplexing layers), and a second mapping or association between the second TCI state group 420-b and the second set of DMRS ports 425-b (or the second set of associated spatial multiplexing layers). Additionally, or alternatively, the DCI 405 may indicate mappings of CDM groups to TRP sets or TCI state groups 420 (one bit). For example, the DCI 405 may indicate that CDM group 0 is associated with the first TCI state group 420-a, and that CDM group 1 is associated with the second TCI state group 420-b.

After receiving the various indications via the DCI 405 (and/or other control signaling), the UE 115 may receive a CJT in accordance with the various mappings. For example, the UE 115 may receive a CJT via the first TCI state group 420-a (e.g., via TRPs associated with the first TCI state group 420-a) in accordance with the various mappings between the first TCI state group 420-a and the DMRS ports 425-a, CDM group 0, supported spatial multiplexing layers, etc. Similarly, by way of another example, the UE 115 may receive a CJT via the second TCI state group 420-b (e.g., via TRPs associated with the second TCI state group 420-b) in accordance with the various mappings between the second TCI state group 420-b and the DMRS ports 425-b, CDM group 1, supported spatial multiplexing layers, etc.

FIG. 5 illustrates an example of a process flow 500 that supports techniques for CJT across multiple TRP sets in accordance with one or more aspects of the present disclosure. In some examples, aspects of the process flow 500 may implement, or be implemented by, aspects of the wireless communications system 100, the wireless communications system 200, the CJT reporting configuration 300, the CJT reporting configuration 400, or any combination thereof. In particular, the process flow 400 illustrates signaling for a UE-based approach for selecting and indicating TRPs included within respective TRP sets for mTRP CJT, as described with respect to FIG. 1-3.

The process flow 500 may include a UE 115-b and a network entity 105-b, which may be examples of UEs 115, network entities 105, and other wireless devices described with reference to FIGS. 1-4. For example, the UE 115-b and the network entity 105-b illustrated in FIG. 5 may be examples of the UE 115-a and the network entity 105-a, respectively, as shown and described in FIG. 2. In this regard, the network entity 105-b may be associated with (e.g., support) multiple TRPs.

In some examples, the operations illustrated in process flow 500 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 505, the UE 115-b may receive control signaling (e.g., RRC, DCI) from the network entity 105-b, where the control signaling indicates a set of multiple TRPs supported by the network entity 105-b and/or other network entities 105. In this regard, the control signaling may indicate candidate TRPs that may be used for CJTs. In some aspects, the control signaling may additionally indicate a set of measurement resources that will be used by the UE 115-b for CSI reporting.

At 510, the UE 115-b may receive reference signals within the set of measurement resources configured via the control signaling at 505. In particular, the UE 115-b may receive the reference signals from the multiple TRPs which were indicated via the control signaling. In this regard, the UE 115-b may receive the reference signals at 510 based on receiving the control signaling at 505.

At 515, the UE 115-b may perform measurements for the reference signals received from the respective TRPs within the set of measurement resources. For example, the UE 115-a may perform measurements in order to perform channel estimation for channels between the UE 115-b and the respective TRPs. In this regard, the UE 115-b may perform the measurements at 515 based on receiving the control signaling at 505, receiving the reference signals at 510, or both.

At 520, the UE 115-b may determine or identify a rank (e.g., RI) and/or spatial multiplexing layers associated with the respective TRPs. The UE 115-a may determine the RIs and/or spatial multiplexing layers associated with the respective TRPs based on the measurements performed at 515. In some aspects, the UE 115-b may group the multiple TRPs into TRP sets based on the identified RIs and/or spatial multiplexing layers. For example, as shown in FIG. 3, the UE 115-b may group the TRPs into a first TRP set 320-a associated with a first RI (or first set of spatial multiplexing layers), and a second TRP set 320-b associated with a second RI (or second set of spatial multiplexing layers).

At 525, the UE 115-b may transmit a CSI report including a first CSI part and a second CSI part. In some aspects, at least one of the first CSI part or the second CSI part indicates a first mapping between a first set of TRPs and a first set of spatial multiplexing layers, and a second mapping between a second set of TRPs and a second set of spatial multiplexing layers. In this regard, the CSI report may indicate the identified RIs/spatial multiplexing layers and corresponding TRP sets which were identified at 520. As such, the UE 115-b may transmit the CSI report at 525 based on receiving the control signaling at 505, receiving the reference signals at 510, performing the measurements at 515, identifying the RI, spatial multiplexing layers, and/or TRP sets at 520, or any combination thereof.

In some aspects, the respective parts of the CSI report may be used to convey different information. For example, in some cases, the first CSI part may include a joint indication of a quantity of TRPs within each of the first set of TRPs and the second set of TRPs, and a corresponding joint RI associated with each of the first set of TRPs and the second set of TRPs. In other words, as shown in FIG. 3, the first CSI part (e.g., first stage 315) may indicate quantities of TRPs 310 within the first TRP set 320-a, the second TRP set 320-b, or both, and corresponding RIs associated with the respective TRP sets 320. For instance, the joint RI may include a first RI associated with the first set of TRPs and a second RI associated with the second set of TRPs.

By way of another example, the second CSI part may include an indication of TRPs included within the first set of TRPs, the second set of TRPs, or both. In other words, the second CSI part may indicate mappings between the TRP sets and the corresponding TRPs (e.g., indicate which TRPs are included within which TRP set). For example, as shown in FIG. 3, the second CSI part (e.g., second stage 325) may indicate mappings between individual TRPs 310 and corresponding TRP sets 320. In some cases, the indication of which TRPs are included in the respective TRP set(s) may include a bitmap, a combination index, or both.

As noted previously herein, the reporting (and the complexity of the reporting) for the second CSI part may be dependent on whether the TRP sets are full-overlapping, non-overlapping, or partial-overlapping. For example, in the case of non-overlapping TRP sets, the second CSI part may include a bitmap, a combination index, or both, which indicates TRPs included within the smaller of the first and second sets of TRPs. By way of another example, in the case of partial-overlapping TRP sets, the second CSI part may indicate at least one TRP that is shared across the first set of TRPs and the second set of TRPs, as well as an indication of at least one additional TRP that is included in the smaller of the first and second sets of TRPs and which is not shared across the first and second sets of TRPs.

At 530, the UE 115-b may receive a phase-coherent joint transmission (e.g., CJT) of a downlink message (e.g., PDSCH message) from at least one of the sets of TRPs (e.g., mTRP CJT). For example, the UE 115-b may receive a CJT of a downlink message from the first set of TRPs in accordance with the first mapping between the first set of TRPs and the first set of spatial multiplexing layers. By way of another example, the UE 115-b may receive a CJT of a downlink message from the second set of TRPs in accordance with the second mapping between the second set of TRPs and the second set of spatial multiplexing layers. As such, the UE 115-b may receive the CJT at 530 based on receiving the control signaling at 505, receiving the reference signals at 510, performing the measurements at 515, identifying the RI, spatial multiplexing layers, and/or TRP sets at 520, transmitting the CSI report at 525, or any combination thereof.

FIG. 6 illustrates an example of a process flow 600 that supports techniques for CJT across multiple TRP sets in accordance with one or more aspects of the present disclosure. In some examples, aspects of the process flow 600 may implement, or be implemented by, aspects of the wireless communications system 100, the wireless communications system 200, the CJT reporting configuration 300, the CJT reporting configuration 400, or any combination thereof. In particular, the process flow 500 illustrates signaling for a gNB-based approach for selecting and indicating TRPs included within respective TRP sets for mTRP CJT, as described with respect to FIGS. 1, 2, and 4.

The process flow 600 may include a UE 115-c and a network entity 105-c, which may be examples of UEs 115, network entities 105, and other wireless devices described with reference to FIGS. 1-5. For example, the UE 115-c and the network entity 105-c illustrated in FIG. 5 may be examples of the UE 115-a and the network entity 105-a, respectively, as shown and described in FIG. 2. In this regard, the network entity 105-c may be associated with (e.g., support) multiple TRPs.

In some examples, the operations illustrated in process flow 600 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 605, the UE 115-c may receive control signaling (e.g., RRC, DCI) from the network entity 105-c, where the control signaling indicates multiple TCI states corresponding to a multiple TRPs associated with (e.g., supported by) the network entity 105-c and/or another network entity 105. In some aspects, the control signaling may indicate a first TCI state group corresponding to a first set of TRPs, and a second TCI state group corresponding to a second set of TRPs.

For example, the control signaling may indicate a bitmap, a combination index, or both, that indicates TRPs included within the first set of TRPs, the second set of TRPs, or both. In particular, the control signaling may indicate a bitmap or combination index indicating TCI states corresponding to the respective TCI state groups.

As noted previously herein, the indications of the respective TCI states included within the respective TCI state groups (and/or TRPs within the TRP sets) may be dependent on whether the TRP sets are full-overlapping, non-overlapping, or partial-overlapping. For example, in the case of non-overlapping TRP sets, the control signaling may include a bitmap, a combination index, or both, which indicates TRPs included within the smaller of the first and second sets of TRPs. By way of another example, in the case of partial-overlapping TRP sets, the control signaling may indicate at least one TRP that is shared across the first set of TRPs and the second set of TRPs, as well as an indication of at least one additional TRP that is included in the smaller of the first and second sets of TRPs and which is not shared across the first and second sets of TRPs.

At 610, the UE 115-c may receive, from the network entity 105-b, indications of mappings between DMRS ports and spatial multiplexing layers. For example, the UE 115-b may receive a mapping between a first set of DMRS ports and a first set of spatial multiplexing layers, and a mapping between a second set of DMRS ports and a second set of spatial multiplexing layers. In some aspects, the mapping shown and described at 610 may be indicated via the control signaling at 605, additional control signaling, or both.

At 615, the UE 115-c may receive, from the network entity 105-b, indications of mappings between the TCI state groups configured via the control signaling at 605 and corresponding DMRS ports, corresponding spatial multiplexing layers, or both. For example, the UE 115-b may receive a first mapping between the first TCI state group and a first set of DMRS ports, a first set of spatial multiplexing layers, or both, and a second mapping between the second TCI state group and a second set of DMRS ports, a second set of spatial multiplexing layers, or both. In this regard, the mappings between the TCI state groups and DMRS ports/layers indicated at 615 may be based on the mappings between the DMRS ports and spatial multiplexing layers indicated at 610. In some aspects, the mappings shown and described at 615 may be indicated via the control signaling at 605, additional control signaling, or both.

In additional or alternative implementations, the UE 115-c may receive (via the control signaling at 605, additional control signaling, or both), an indication of a first CDM group associated with the first set of DMRS ports, and a second CDM group associated with the second set of DMRS ports.

At 620, the UE 115-b may monitor for a phase-coherent joint transmission (e.g., CJT) of a downlink message. IN particular, the UE 115-c may monitor for mTRP CJTs at 620 in accordance with the various mappings and relationships indicated at 605 through 615.

At 625, the UE 115-c may receive a phase-coherent joint transmission (e.g., CJT) of a downlink message (e.g., PDSCH message) from at least one of the sets of TRPs (e.g., mTRP CJT). For example, the UE 115-c may receive a CJT of a downlink message from the first set of TRPs in accordance with the first mapping between the first set of TRPs and the first set of DMRS ports. By way of another example, the UE 115-c may receive a CJT of a downlink message from the second set of TRPs in accordance with the second mapping between the second set of TRPs and the second set of DMRS ports. As such, the UE 115-c may receive the CJT at 625 based on receiving the control signaling at 605, receiving the various mappings at 610 and 615, monitoring for the CJT(s) at 620, or any combination thereof.

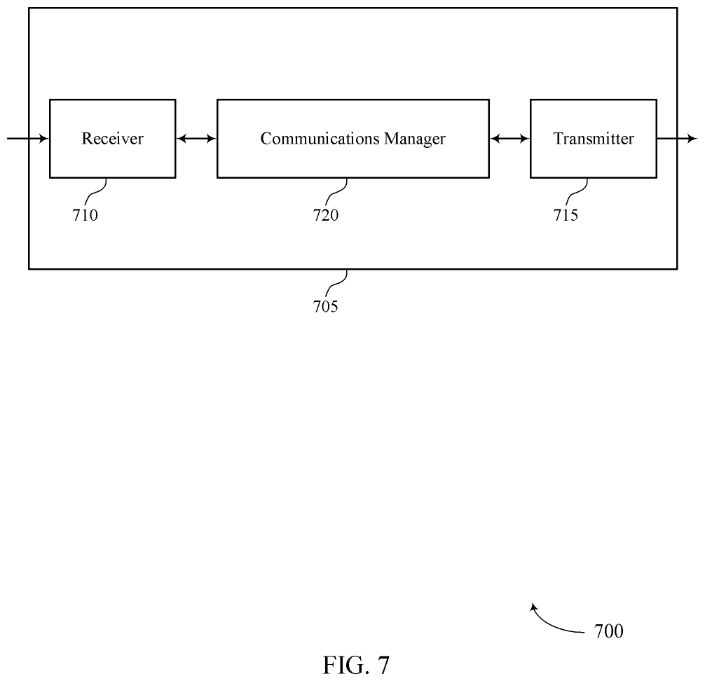

FIG. 7 shows a block diagram 700 of a device 705 that supports techniques for CJT across multiple TRP sets in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for CJT across multiple TRP sets). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for CJT across multiple TRP sets). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of techniques for CJT across multiple TRP sets as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. For example, the communications manager 720 may be configured as or otherwise support a means for receiving control signaling indicating a set of multiple TRPs and a set of measurement resources. The communications manager 720 may be configured as or otherwise support a means for performing measurements for a set of multiple reference signals received from the set of multiple TRPs within the set of measurement resources. The communications manager 720 may be configured as or otherwise support a means for transmitting a CSI report including a first CSI part and a second CSI part, at least one of the first CSI part or the second CSI part indicating a first mapping between a first set of TRPs of the set of multiple TRPs and a first set of spatial multiplexing layers, and indicating a second mapping between a second set of TRPs of the set of multiple TRPs and a second set of spatial multiplexing layers based on the measurements. The communications manager 720 may be configured as or otherwise support a means for receiving a phase-coherent joint transmission of a downlink message from the first set of TRPs in accordance with the first mapping, or from the second set of TRPs in accordance with the second mapping.

Additionally, or alternatively, the communications manager 720 may support wireless communication at a UE in accordance with examples as disclosed herein. For example, the communications manager 720 may be configured as or otherwise support a means for receiving control signaling indicating a set of multiple TCI states corresponding to a set of multiple TRPs, the control signaling indicating a first TCI state group of the set of multiple TCI states corresponding to a first set of TRPs of the set of multiple TRPs, and a second TCI state group of the set of multiple TCI states corresponding to a second set of TRPs of the set of multiple TRPs. The communications manager 720 may be configured as or otherwise support a means for receiving a first mapping between the first TCI state group and a first set of DMRS ports, a first set of spatial multiplexing layers, or both, and a second mapping between the second TCI state group and a second set of DMRS ports, a second set of spatial multiplexing layers, or both. The communications manager 720 may be configured as or otherwise support a means for monitoring for a phase-coherent joint transmission of a downlink message from the first set of TRPs in accordance with the first mapping, or from the second set of TRPs in accordance with the second mapping.

By including or configuring the communications manager 720 in accordance with examples as described herein, the device 705 (e.g., a processor controlling or otherwise coupled with the receiver 710, the transmitter 715, the communications manager 720, or a combination thereof) may support techniques that enable TRPs to be grouped into sets that support the same quantities of spatial multiplexing layers, thereby facilitating more efficient and widespread use of mTRP CJTs, which may improve coverage and average throughput within the wireless communications system 100. Moreover, by grouping TRPs based on supported quantities of spatial multiplexing layers (e.g., by grouping TRPs based on rank), CSI reporting at UEs 115 in response to mTRP CJTs may be simplified. In particular, grouping TRPs by rank may reduce a CSI processing complexity at the UEs 115, and reduce a size of CSI reports, thereby reducing control signaling overhead and leading to a more efficient use of communication resources.

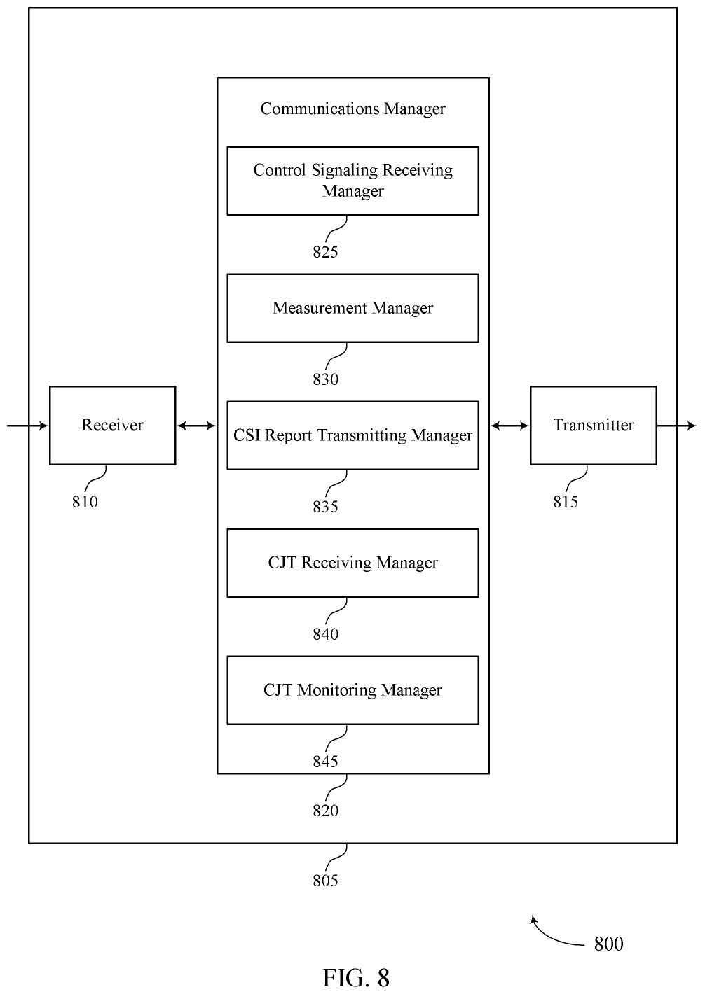

FIG. 8 shows a block diagram 800 of a device 805 that supports techniques for CJT across multiple TRP sets in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for CJT across multiple TRP sets). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for CJT across multiple TRP sets). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for CJT across multiple TRP sets as described herein. For example, the communications manager 820 may include a control signaling receiving manager 825, a measurement manager 830, a CSI report transmitting manager 835, a CJT receiving manager 840, a CJT monitoring manager 845, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. The control signaling receiving manager 825 may be configured as or otherwise support a means for receiving control signaling indicating a set of multiple TRPs and a set of measurement resources. The measurement manager 830 may be configured as or otherwise support a means for performing measurements for a set of multiple reference signals received from the set of multiple TRPs within the set of measurement resources. The CSI report transmitting manager 835 may be configured as or otherwise support a means for transmitting a CSI report including a first CSI part and a second CSI part, at least one of the first CSI part or the second CSI part indicating a first mapping between a first set of TRPs of the set of multiple TRPs and a first set of spatial multiplexing layers, and indicating a second mapping between a second set of TRPs of the set of multiple TRPs and a second set of spatial multiplexing layers based on the measurements. The CJT receiving manager 840 may be configured as or otherwise support a means for receiving a phase-coherent joint transmission of a downlink message from the first set of TRPs in accordance with the first mapping, or from the second set of TRPs in accordance with the second mapping.

Additionally, or alternatively, the communications manager 820 may support wireless communication at a UE in accordance with examples as disclosed herein. The control signaling receiving manager 825 may be configured as or otherwise support a means for receiving control signaling indicating a set of multiple TCI states corresponding to a set of multiple TRPs, the control signaling indicating a first TCI state group of the set of multiple TCI states corresponding to a first set of TRPs of the set of multiple TRPs, and a second TCI state group of the set of multiple TCI states corresponding to a second set of TRPs of the set of multiple TRPs. The control signaling receiving manager 825 may be configured as or otherwise support a means for receiving a first mapping between the first TCI state group and a first set of DMRS ports, a first set of spatial multiplexing layers, or both, and a second mapping between the second TCI state group and a second set of DMRS ports, a second set of spatial multiplexing layers, or both. The CJT monitoring manager 845 may be configured as or otherwise support a means for monitoring for a phase-coherent joint transmission of a downlink message from the first set of TRPs in accordance with the first mapping, or from the second set of TRPs in accordance with the second mapping.

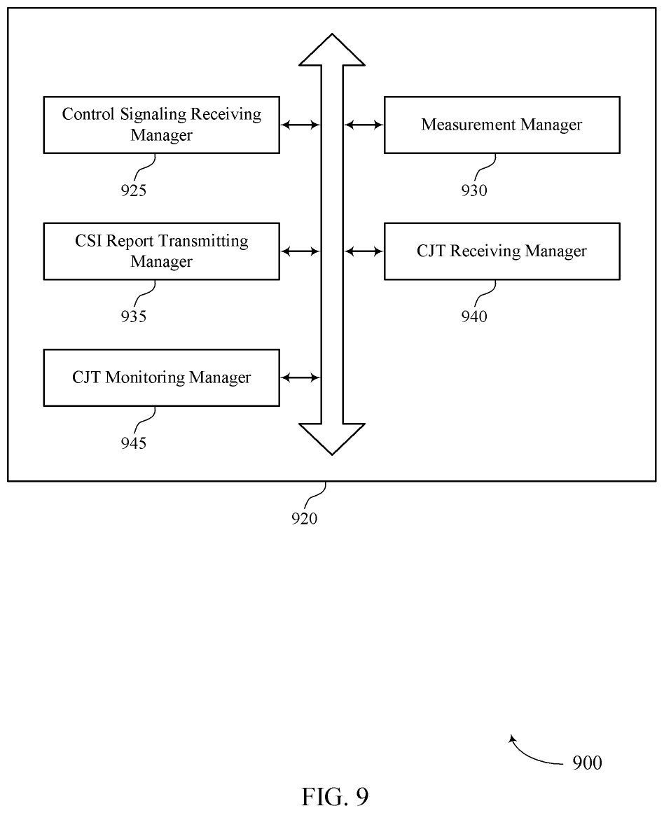

FIG. 9 shows a block diagram 900 of a communications manager 920 that supports techniques for CJT across multiple TRP sets in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for CJT across multiple TRP sets as described herein. For example, the communications manager 920 may include a control signaling receiving manager 925, a measurement manager 930, a CSI report transmitting manager 935, a CJT receiving manager 940, a CJT monitoring manager 945, or any combination thereof. Each of these components may communicate, directly or indirectly, with one another (e.g., via one or more buses).

The communications manager 920 may support wireless communication at a UE in accordance with examples as disclosed herein. The control signaling receiving manager 925 may be configured as or otherwise support a means for receiving control signaling indicating a set of multiple TRPs and a set of measurement resources. The measurement manager 930 may be configured as or otherwise support a means for performing measurements for a set of multiple reference signals received from the set of multiple TRPs within the set of measurement resources. The CSI report transmitting manager 935 may be configured as or otherwise support a means for transmitting a CSI report including a first CSI part and a second CSI part, at least one of the first CSI part or the second CSI part indicating a first mapping between a first set of TRPs of the set of multiple TRPs and a first set of spatial multiplexing layers, and indicating a second mapping between a second set of TRPs of the set of multiple TRPs and a second set of spatial multiplexing layers based on the measurements. The CJT receiving manager 940 may be configured as or otherwise support a means for receiving a phase-coherent joint transmission of a downlink message from the first set of TRPs in accordance with the first mapping, or from the second set of TRPs in accordance with the second mapping.

In some examples, the first CSI part includes a joint indication of a quantity of TRPs within each of the first set of TRPs and the second set of TRPs, and a corresponding joint RI associated with each of the first set of TRPs and the second set of TRPs.

In some examples, the joint RI includes a first RI associated with the first set of TRPs and a second RI associated with the second set of TRPs. In some examples, the second CSI part includes an indication of TRPs included within the first set of TRPs, the second set of TRPs, or both. In some examples, the indication of the TRPs includes a bitmap, a combination index, or both.

In some examples, the control signaling receiving manager 925 may be configured as or otherwise support a means for receiving, via the control signaling, an indication of the first set of TRPs and the second set of TRPs, where an indication of the first mapping and the second mapping is included in the first CSI part.

In some examples, the first set of TRPs is mutually exclusive with respect to the second set of TRPs, and the CSI report transmitting manager 935 may be configured as or otherwise support a means for transmitting, via the CSI report, a bitmap, a combination index, or both, which indicates TRPs included within one of the first set of TRPs or the second set of TRPs that includes fewer TRPs.

In some examples, the CSI report transmitting manager 935 may be configured as or otherwise support a means for transmitting, via the CSI report, an indication of at least one TRP that is shared across the first set of TRPs and the second set of TRPs, and an indication of at least one additional TRP that is included in one of the first set of TRPs or the second set of TRPs with a smaller size and which is not shared across the first set of TRPs and the second set of TRPs.

Additionally, or alternatively, the communications manager 920 may support wireless communication at a UE in accordance with examples as disclosed herein. In some examples, the control signaling receiving manager 925 may be configured as or otherwise support a means for receiving control signaling indicating a set of multiple TCI states corresponding to a set of multiple TRPs, the control signaling indicating a first TCI state group of the set of multiple TCI states corresponding to a first set of TRPs of the set of multiple TRPs, and a second TCI state group of the set of multiple TCI states corresponding to a second set of TRPs of the set of multiple TRPs. In some examples, the control signaling receiving manager 925 may be configured as or otherwise support a means for receiving a first mapping between the first TCI state group and a first set of DMRS ports, a first set of spatial multiplexing layers, or both, and a second mapping between the second TCI state group and a second set of DMRS ports, a second set of spatial multiplexing layers, or both. The CJT monitoring manager 945 may be configured as or otherwise support a means for monitoring for a phase-coherent joint transmission of a downlink message from the first set of TRPs in accordance with the first mapping, or from the second set of TRPs in accordance with the second mapping.

In some examples, the control signaling receiving manager 925 may be configured as or otherwise support a means for receiving, via the control signaling, a third mapping between the first set of DMRS ports and the first set of spatial multiplexing layers, and a fourth mapping between the second set of DMRS ports and the second set of spatial multiplexing layers, where the first mapping is based on the third mapping, and where the second mapping is based on the fourth mapping.

In some examples, the control signaling receiving manager 925 may be configured as or otherwise support a means for receiving, via the control signaling, a bitmap, a combination index, or both, that indicates TRPs included within the first set of TRPs, the second set of TRPs, or both.

In some examples, the control signaling receiving manager 925 may be configured as or otherwise support a means for receiving, via the control signaling, a bitmap that indicates TCI states within the first TCI state group, the second TCI state group, or both.

In some examples, the control signaling receiving manager 925 may be configured as or otherwise support a means for receiving, via the control signaling, an indication of a first CDM group associated with the first set of DMRS ports, and a second CDM group associated with the second set of DMRS ports, where monitoring for the phase-coherent joint transmission of the downlink message is based on the indication of the first CDM group, the second CDM group, or both. In some examples, the control signaling includes RRC signaling, DCI signaling, or both.

In some examples, the first set of TRPs is mutually exclusive with respect to the second set of TRPs, and the control signaling receiving manager 925 may be configured as or otherwise support a means for receiving, via the control signaling, a bitmap, a combination index, or both, which indicates TRPs included within one of the first set of TRPs or the second set of TRPs that includes fewer TRPs.

In some examples, the first set of TRPs is mutually exclusive with respect to the second set of TRPs, and the control signaling receiving manager 925 may be configured as or otherwise support a means for receiving, via the control signaling, a bitmap, a combination index, or both, which indicates TRPs included within one of the first set of TRPs or the second set of TRPs that includes fewer TRPs.

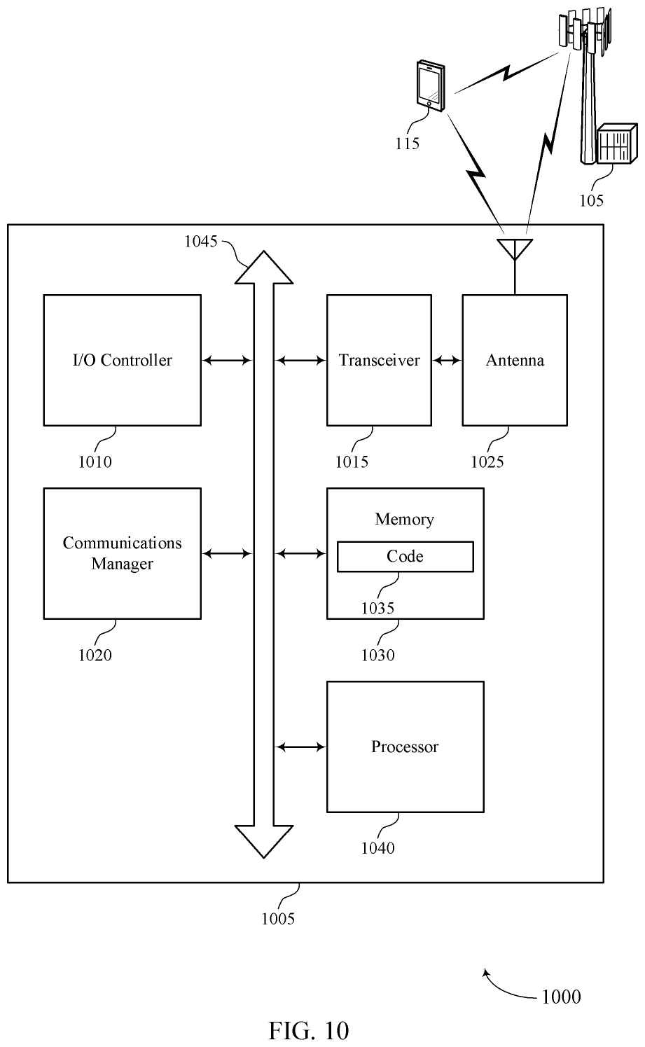

FIG. 10 shows a diagram of a system 1000 including a device 1005 that supports techniques for CJT across multiple TRP sets in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting techniques for CJT across multiple TRP sets). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for receiving control signaling indicating a set of multiple TRPs and a set of measurement resources. The communications manager 1020 may be configured as or otherwise support a means for performing measurements for a set of multiple reference signals received from the set of multiple TRPs within the set of measurement resources. The communications manager 1020 may be configured as or otherwise support a means for transmitting a CSI report including a first CSI part and a second CSI part, at least one of the first CSI part or the second CSI part indicating a first mapping between a first set of TRPs of the set of multiple TRPs and a first set of spatial multiplexing layers, and indicating a second mapping between a second set of TRPs of the set of multiple TRPs and a second set of spatial multiplexing layers based on the measurements. The communications manager 1020 may be configured as or otherwise support a means for receiving a phase-coherent joint transmission of a downlink message from the first set of TRPs in accordance with the first mapping, or from the second set of TRPs in accordance with the second mapping.

Additionally, or alternatively, the communications manager 1020 may support wireless communication at a UE in accordance with examples as disclosed herein. For example, the communications manager 1020 may be configured as or otherwise support a means for receiving control signaling indicating a set of multiple TCI states corresponding to a set of multiple TRPs, the control signaling indicating a first TCI state group of the set of multiple TCI states corresponding to a first set of TRPs of the set of multiple TRPs, and a second TCI state group of the set of multiple TCI states corresponding to a second set of TRPs of the set of multiple TRPs. The communications manager 1020 may be configured as or otherwise support a means for receiving a first mapping between the first TCI state group and a first set of DMRS ports, a first set of spatial multiplexing layers, or both, and a second mapping between the second TCI state group and a second set of DMRS ports, a second set of spatial multiplexing layers, or both. The communications manager 1020 may be configured as or otherwise support a means for monitoring for a phase-coherent joint transmission of a downlink message from the first set of TRPs in accordance with the first mapping, or from the second set of TRPs in accordance with the second mapping.

By including or configuring the communications manager 1020 in accordance with examples as described herein, the device 1005 may support techniques that enable TRPs to be grouped into sets that support the same quantities of spatial multiplexing layers, thereby facilitating more efficient and widespread use of mTRP CJTs, which may improve coverage and average throughput within the wireless communications system 100. Moreover, by grouping TRPs based on supported quantities of spatial multiplexing layers (e.g., by grouping TRPs based on rank), CSI reporting at UEs 115 in response to mTRP CJTs may be simplified. In particular, grouping TRPs by rank may reduce a CSI processing complexity at the UEs 115, and reduce a size of CSI reports, thereby reducing control signaling overhead and leading to a more efficient use of communication resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of techniques for CJT across multiple TRP sets as described herein, or the processor 1040 and the memory 1030 may be otherwise configured to perform or support such operations.

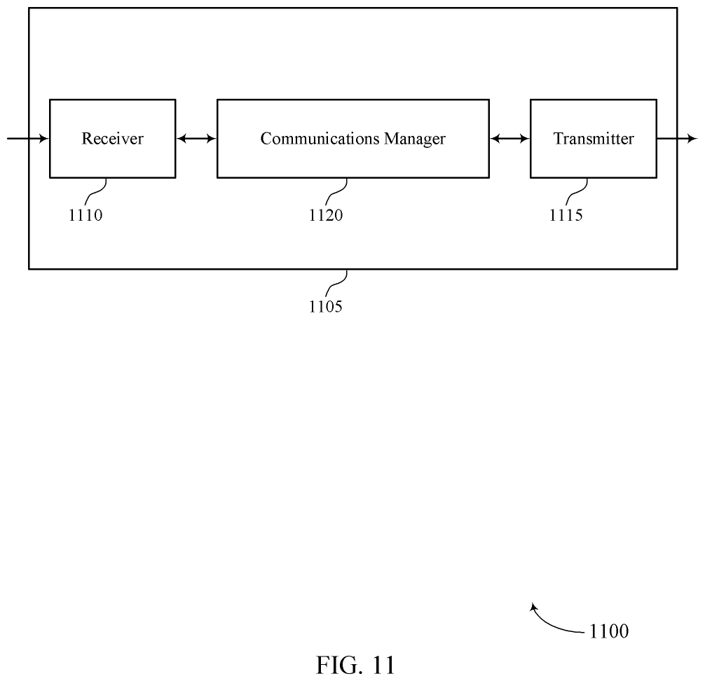

FIG. 11 shows a block diagram 1100 of a device 1105 that supports techniques for CJT across multiple TRP sets in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of techniques for CJT across multiple TRP sets as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. For example, the communications manager 1120 may be configured as or otherwise support a means for transmitting, to a UE, control signaling indicating a set of multiple TRPs and a set of measurement resources. The communications manager 1120 may be configured as or otherwise support a means for transmitting a set of multiple reference signals via the set of multiple TRPs within the set of measurement resources. The communications manager 1120 may be configured as or otherwise support a means for receiving, from the UE and based on the set of multiple reference signals, a CSI report including a first CSI part and a second CSI part, at least one of the first CSI part or the second CSI part indicating a first mapping between a first set of TRPs of the set of multiple TRPs and a first set of spatial multiplexing layers, and indicating a second mapping between a second set of TRPs of the set of multiple TRPs and a second set of spatial multiplexing layers. The communications manager 1120 may be configured as or otherwise support a means for transmitting, to the UE, a phase-coherent joint transmission of a downlink message from the first set of TRPs in accordance with the first mapping, or from the second set of TRPs in accordance with the second mapping.

Additionally, or alternatively, the communications manager 1120 may support wireless communication at a network entity in accordance with examples as disclosed herein. For example, the communications manager 1120 may be configured as or otherwise support a means for transmitting, to a UE, control signaling indicating a set of multiple TCI states corresponding to a set of multiple TRPs, the control signaling indicating a first TCI state group of the set of multiple TCI states corresponding to a first set of TRPs of the set of multiple TRPs, and a second TCI state group of the set of multiple TCI states corresponding to a second set of TRPs of the set of multiple TRPs. The communications manager 1120 may be configured as or otherwise support a means for transmitting, to the UE, a first mapping between the first TCI state group and a first set of DMRS ports, a first set of spatial multiplexing layers, or both, and a second mapping between the second TCI state group and a second set of DMRS ports, a second set of spatial multiplexing layers, or both. The communications manager 1120 may be configured as or otherwise support a means for transmitting a phase-coherent joint transmission of a downlink message from the first set of TRPs in accordance with the first mapping, or from the second set of TRPs in accordance with the second mapping.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques that enable TRPs to be grouped into sets that support the same quantities of spatial multiplexing layers, thereby facilitating more efficient and widespread use of mTRP CJTs, which may improve coverage and average throughput within the wireless communications system 100. Moreover, by grouping TRPs based on supported quantities of spatial multiplexing layers (e.g., by grouping TRPs based on rank), CSI reporting at UEs 115 in response to mTRP CJTs may be simplified. In particular, grouping TRPs by rank may reduce a CSI processing complexity at the UEs 115, and reduce a size of CSI reports, thereby reducing control signaling overhead and leading to a more efficient use of communication resources.

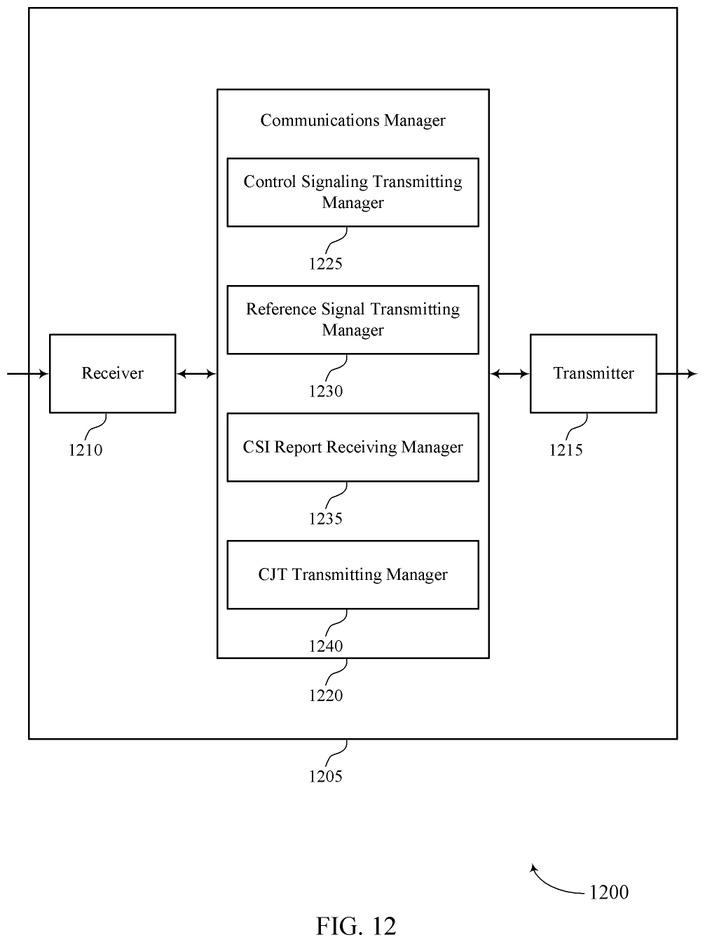

FIG. 12 shows a block diagram 1200 of a device 1205 that supports techniques for CJT across multiple TRP sets in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for CJT across multiple TRP sets as described herein. For example, the communications manager 1220 may include a control signaling transmitting manager 1225, a reference signal transmitting manager 1230, a CSI report receiving manager 1235, a CJT transmitting manager 1240, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. The control signaling transmitting manager 1225 may be configured as or otherwise support a means for transmitting, to a UE, control signaling indicating a set of multiple TRPs and a set of measurement resources. The reference signal transmitting manager 1230 may be configured as or otherwise support a means for transmitting a set of multiple reference signals via the set of multiple TRPs within the set of measurement resources. The CSI report receiving manager 1235 may be configured as or otherwise support a means for receiving, from the UE and based on the set of multiple reference signals, a CSI report including a first CSI part and a second CSI part, at least one of the first CSI part or the second CSI part indicating a first mapping between a first set of TRPs of the set of multiple TRPs and a first set of spatial multiplexing layers, and indicating a second mapping between a second set of TRPs of the set of multiple TRPs and a second set of spatial multiplexing layers. The CJT transmitting manager 1240 may be configured as or otherwise support a means for transmitting, to the UE, a phase-coherent joint transmission of a downlink message from the first set of TRPs in accordance with the first mapping, or from the second set of TRPs in accordance with the second mapping.

Additionally, or alternatively, the communications manager 1220 may support wireless communication at a network entity in accordance with examples as disclosed herein. The control signaling transmitting manager 1225 may be configured as or otherwise support a means for transmitting, to a UE, control signaling indicating a set of multiple TCI states corresponding to a set of multiple TRPs, the control signaling indicating a first TCI state group of the set of multiple TCI states corresponding to a first set of TRPs of the set of multiple TRPs, and a second TCI state group of the set of multiple TCI states corresponding to a second set of TRPs of the set of multiple TRPs. The control signaling transmitting manager 1225 may be configured as or otherwise support a means for transmitting, to the UE, a first mapping between the first TCI state group and a first set of DMRS ports, a first set of spatial multiplexing layers, or both, and a second mapping between the second TCI state group and a second set of DMRS ports, a second set of spatial multiplexing layers, or both. The CJT transmitting manager 1240 may be configured as or otherwise support a means for transmitting a phase-coherent joint transmission of a downlink message from the first set of TRPs in accordance with the first mapping, or from the second set of TRPs in accordance with the second mapping.

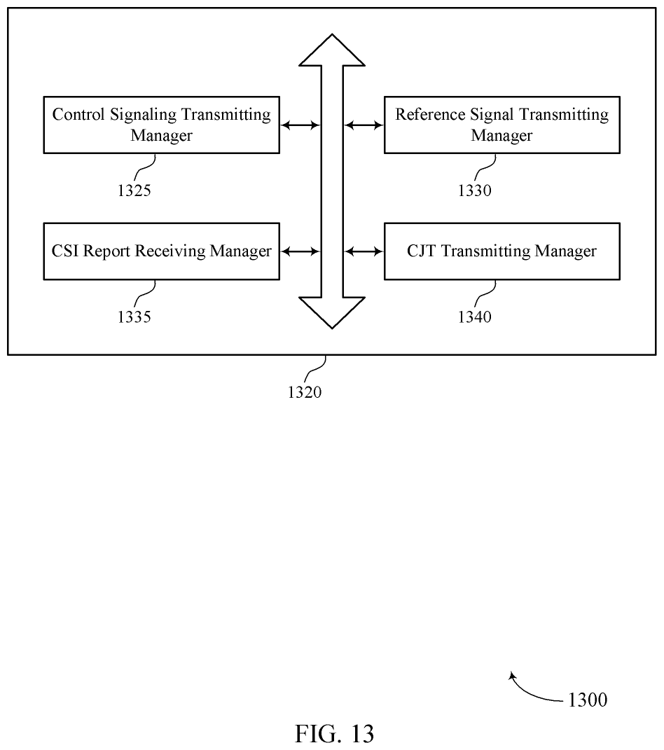

FIG. 13 shows a block diagram 1300 of a communications manager 1320 that supports techniques for CJT across multiple TRP sets in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for CJT across multiple TRP sets as described herein. For example, the communications manager 1320 may include a control signaling transmitting manager 1325, a reference signal transmitting manager 1330, a CSI report receiving manager 1335, a CJT transmitting manager 1340, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The control signaling transmitting manager 1325 may be configured as or otherwise support a means for transmitting, to a UE, control signaling indicating a set of multiple TRPs and a set of measurement resources. The reference signal transmitting manager 1330 may be configured as or otherwise support a means for transmitting a set of multiple reference signals via the set of multiple TRPs within the set of measurement resources. The CSI report receiving manager 1335 may be configured as or otherwise support a means for receiving, from the UE and based on the set of multiple reference signals, a CSI report including a first CSI part and a second CSI part, at least one of the first CSI part or the second CSI part indicating a first mapping between a first set of TRPs of the set of multiple TRPs and a first set of spatial multiplexing layers, and indicating a second mapping between a second set of TRPs of the set of multiple TRPs and a second set of spatial multiplexing layers. The CJT transmitting manager 1340 may be configured as or otherwise support a means for transmitting, to the UE, a phase-coherent joint transmission of a downlink message from the first set of TRPs in accordance with the first mapping, or from the second set of TRPs in accordance with the second mapping.

In some examples, the first CSI part includes a joint indication of a quantity of TRPs within each of the first set of TRPs and the second set of TRPs, and a corresponding joint RI associated with each of the first set of TRPs and the second set of TRPs.

In some examples, the joint RI includes a first RI associated with the first set of TRPs and a second RI associated with the second set of TRPs. In some examples, the second CSI part includes an indication of TRPs included within the first set of TRPs, the second set of TRPs, or both. In some examples, the indication of the TRPs includes a bitmap, a combination index, or both.

In some examples, the control signaling transmitting manager 1325 may be configured as or otherwise support a means for transmitting, via the control signaling, an indication of the first set of TRPs and the second set of TRPs, where the indication of the first mapping and the second mapping is included in the first CSI part.

In some examples, the first set of TRPs is mutually exclusive with respect to the second set of TRPs, and the CSI report receiving manager 1335 may be configured as or otherwise support a means for receiving, via the CSI report, a bitmap, a combination index, or both, which indicates TRPs included within one of the first set of TRPs or the second set of TRPs that includes fewer TRPs.

In some examples, the CSI report receiving manager 1335 may be configured as or otherwise support a means for receiving, via the CSI report, an indication of at least one TRP that is shared across the first set of TRPs and the second set of TRPs, and an indication of at least one additional TRP that is included in one of the first set of TRPs or the second set of TRPs with a smaller size and which is not shared across the first set of TRPs and the second set of TRPs.

Additionally, or alternatively, the communications manager 1320 may support wireless communication at a network entity in accordance with examples as disclosed herein. In some examples, the control signaling transmitting manager 1325 may be configured as or otherwise support a means for transmitting, to a UE, control signaling indicating a set of multiple TCI states corresponding to a set of multiple TRPs, the control signaling indicating a first TCI state group of the set of multiple TCI states corresponding to a first set of TRPs of the set of multiple TRPs, and a second TCI state group of the set of multiple TCI states corresponding to a second set of TRPs of the set of multiple TRPs. In some examples, the control signaling transmitting manager 1325 may be configured as or otherwise support a means for transmitting, to the UE, a first mapping between the first TCI state group and a first set of DMRS ports, a first set of spatial multiplexing layers, or both, and a second mapping between the second TCI state group and a second set of DMRS ports, a second set of spatial multiplexing layers, or both. In some examples, the CJT transmitting manager 1340 may be configured as or otherwise support a means for transmitting a phase-coherent joint transmission of a downlink message from the first set of TRPs in accordance with the first mapping, or from the second set of TRPs in accordance with the second mapping.

In some examples, the control signaling transmitting manager 1325 may be configured as or otherwise support a means for transmitting, via the control signaling, a third mapping between the first set of DMRS ports and the first set of spatial multiplexing layers, and a fourth mapping between the second set of DMRS ports and the second set of spatial multiplexing layers, where the first mapping is based on the third mapping, and where the second mapping is based on the fourth mapping.

In some examples, the control signaling transmitting manager 1325 may be configured as or otherwise support a means for transmitting, via the control signaling, a bitmap, a combination index, or both, that indicates TRPs included within the first set of TRPs, the second set of TRPs, or both.

In some examples, the control signaling transmitting manager 1325 may be configured as or otherwise support a means for transmitting, via the control signaling, a bitmap that indicates TCI states within the first TCI state group, the second TCI state group, or both.

In some examples, the control signaling transmitting manager 1325 may be configured as or otherwise support a means for transmitting, via the control signaling, an indication of a first CDM group associated with the first set of DMRS ports, and a second CDM group associated with the second set of DMRS ports, where transmitting the phase-coherent joint transmission of the downlink message is based on the indication of the first CDM group, the second CDM group, or both.

In some examples, the control signaling includes RRC signaling, DCI signaling, or both.

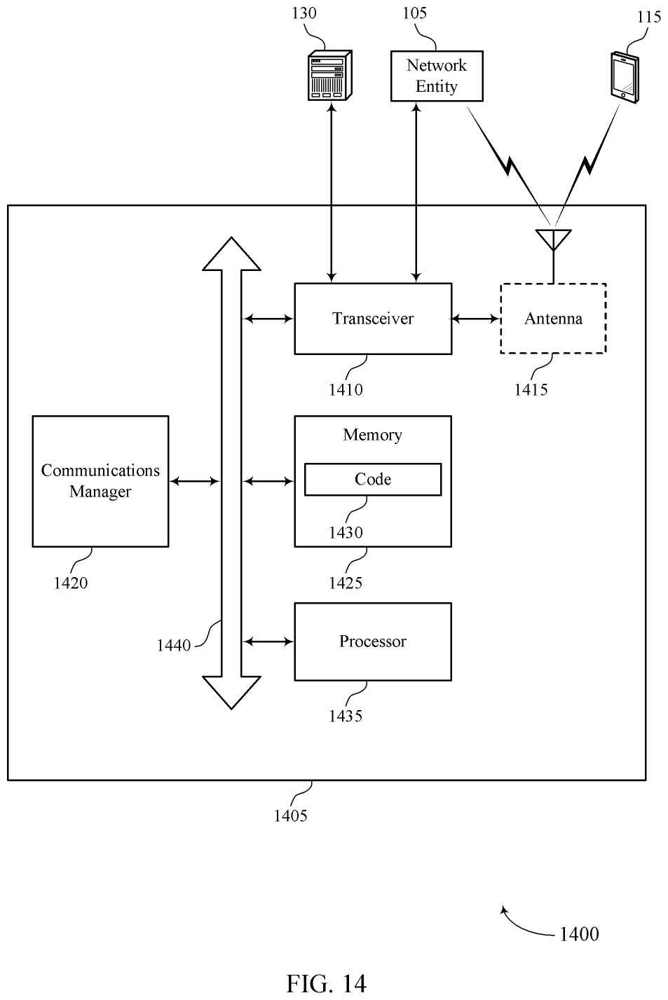

FIG. 14 shows a diagram of a system 1400 including a device 1405 that supports techniques for CJT across multiple TRP sets in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting techniques for CJT across multiple TRP sets). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity in accordance with examples as disclosed herein. For example, the communications manager 1420 may be configured as or otherwise support a means for transmitting, to a UE, control signaling indicating a set of multiple TRPs and a set of measurement resources. The communications manager 1420 may be configured as or otherwise support a means for transmitting a set of multiple reference signals via the set of multiple TRPs within the set of measurement resources. The communications manager 1420 may be configured as or otherwise support a means for receiving, from the UE and based on the set of multiple reference signals, a CSI report including a first CSI part and a second CSI part, at least one of the first CSI part or the second CSI part indicating a first mapping between a first set of TRPs of the set of multiple TRPs and a first set of spatial multiplexing layers, and indicating a second mapping between a second set of TRPs of the set of multiple TRPs and a second set of spatial multiplexing layers. The communications manager 1420 may be configured as or otherwise support a means for transmitting, to the UE, a phase-coherent joint transmission of a downlink message from the first set of TRPs in accordance with the first mapping, or from the second set of TRPs in accordance with the second mapping.

Additionally, or alternatively, the communications manager 1420 may support wireless communication at a network entity in accordance with examples as disclosed herein. For example, the communications manager 1420 may be configured as or otherwise support a means for transmitting, to a UE, control signaling indicating a set of multiple TCI states corresponding to a set of multiple TRPs, the control signaling indicating a first TCI state group of the set of multiple TCI states corresponding to a first set of TRPs of the set of multiple TRPs, and a second TCI state group of the set of multiple TCI states corresponding to a second set of TRPs of the set of multiple TRPs. The communications manager 1420 may be configured as or otherwise support a means for transmitting, to the UE, a first mapping between the first TCI state group and a first set of DMRS ports, a first set of spatial multiplexing layers, or both, and a second mapping between the second TCI state group and a second set of DMRS ports, a second set of spatial multiplexing layers, or both. The communications manager 1420 may be configured as or otherwise support a means for transmitting a phase-coherent joint transmission of a downlink message from the first set of TRPs in accordance with the first mapping, or from the second set of TRPs in accordance with the second mapping.

By including or configuring the communications manager 1420 in accordance with examples as described herein, the device 1405 may support techniques that enable TRPs to be grouped into sets that support the same quantities of spatial multiplexing layers, thereby facilitating more efficient and widespread use of mTRP CJTs, which may improve coverage and average throughput within the wireless communications system 100. Moreover, by grouping TRPs based on supported quantities of spatial multiplexing layers (e.g., by grouping TRPs based on rank), CSI reporting at UEs 115 in response to mTRP CJTs may be simplified. In particular, grouping TRPs by rank may reduce a CSI processing complexity at the UEs 115, and reduce a size of CSI reports, thereby reducing control signaling overhead and leading to a more efficient use of communication resources.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of techniques for CJT across multiple TRP sets as described herein, or the processor 1435 and the memory 1425 may be otherwise configured to perform or support such operations.

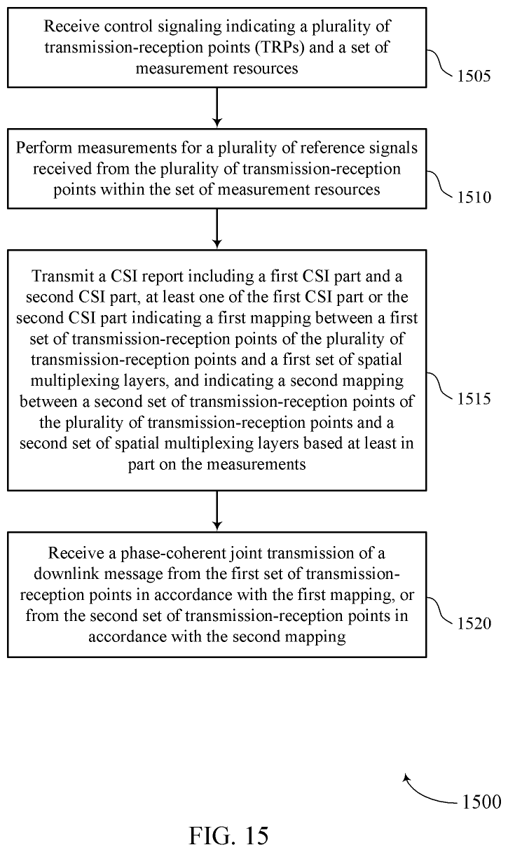

FIG. 15 shows a flowchart illustrating a method 1500 that supports techniques for CJT across multiple TRP sets in accordance with one or more aspects of the present disclosure. The operations of the method 1500 may be implemented by a UE or the UE's components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving control signaling indicating a set of multiple TRPs and a set of measurement resources. The operations of 1505 may be performed in accordance with examples as disclosed herein. In some examples, aspects of the operations of 1505 may be performed by a control signaling receiving manager 925 as described with reference to FIG. 9.

At 1510, the method may include performing measurements for a set of multiple reference signals received from the set of multiple TRPs within the set of measurement resources. The operations of 1510 may be performed in accordance with examples as disclosed herein. In some examples, aspects of the operations of 1510 may be performed by a measurement manager 930 as described with reference to FIG. 9.

At 1515, the method may include transmitting a CSI report including a first CSI part and a second CSI part, at least one of the first CSI part or the second CSI part indicating a first mapping between a first set of TRPs of the set of multiple TRPs and a first set of spatial multiplexing layers, and indicating a second mapping between a second set of TRPs of the set of multiple TRPs and a second set of spatial multiplexing layers based on the measurements. The operations of 1515 may be performed in accordance with examples as disclosed herein. In some examples, aspects of the operations of 1515 may be performed by a CSI report transmitting manager 935 as described with reference to FIG. 9.

At 1520, the method may include receiving a phase-coherent joint transmission of a downlink message from the first set of TRPs in accordance with the first mapping, or from the second set of TRPs in accordance with the second mapping. The operations of 1520 may be performed in accordance with examples as disclosed herein. In some examples, aspects of the operations of 1520 may be performed by a CJT receiving manager 940 as described with reference to FIG. 9.

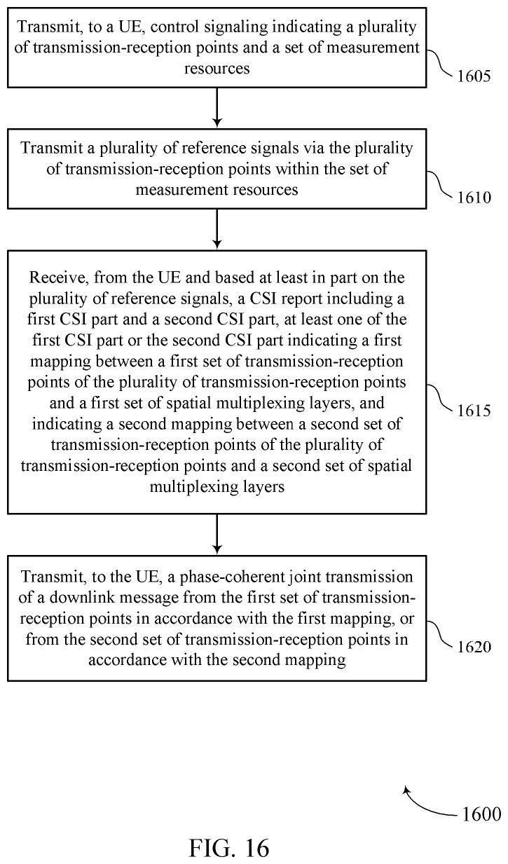

FIG. 16 shows a flowchart illustrating a method 1600 that supports techniques for CJT across multiple TRP sets in accordance with one or more aspects of the present disclosure. The operations of the method 1600 may be implemented by a network entity or the network entity's components as described herein. For example, the operations of the method 1600 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to a UE, control signaling indicating a set of multiple TRPs and a set of measurement resources. The operations of 1605 may be performed in accordance with examples as disclosed herein. In some examples, aspects of the operations of 1605 may be performed by a control signaling transmitting manager 1325 as described with reference to FIG. 13.

At 1610, the method may include transmitting a set of multiple reference signals via the set of multiple TRPs within the set of measurement resources. The operations of 1610 may be performed in accordance with examples as disclosed herein. In some examples, aspects of the operations of 1610 may be performed by a reference signal transmitting manager 1330 as described with reference to FIG. 13.

At 1615, the method may include receiving, from the UE and based on the set of multiple reference signals, a CSI report including a first CSI part and a second CSI part, at least one of the first CSI part or the second CSI part indicating a first mapping between a first set of TRPs of the set of multiple TRPs and a first set of spatial multiplexing layers, and indicating a second mapping between a second set of TRPs of the set of multiple TRPs and a second set of spatial multiplexing layers. The operations of 1615 may be performed in accordance with examples as disclosed herein. In some examples, aspects of the operations of 1615 may be performed by a CSI report receiving manager 1335 as described with reference to FIG. 13.

At 1620, the method may include transmitting, to the UE, a phase-coherent joint transmission of a downlink message from the first set of TRPs in accordance with the first mapping, or from the second set of TRPs in accordance with the second mapping. The operations of 1620 may be performed in accordance with examples as disclosed herein. In some examples, aspects of the operations of 1620 may be performed by a CJT transmitting manager 1340 as described with reference to FIG. 13.

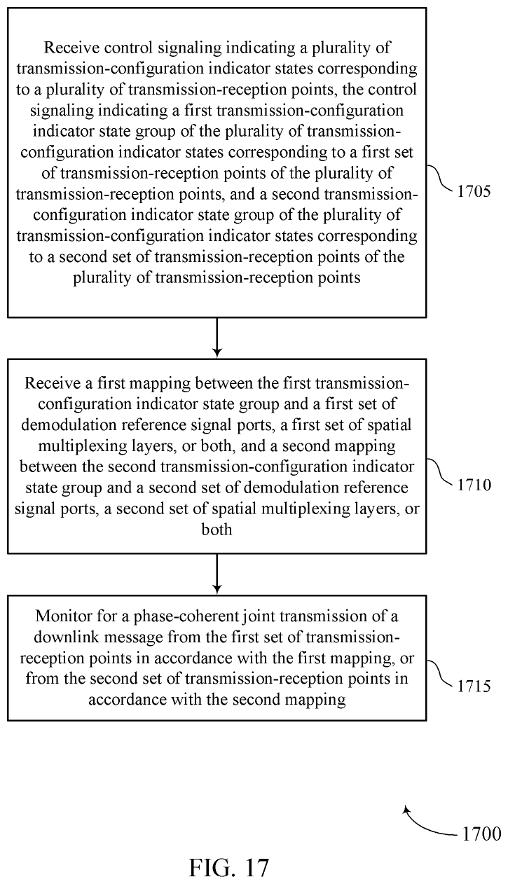

FIG. 17 shows a flowchart illustrating a method 1700 that supports techniques for CJT across multiple TRP sets in accordance with one or more aspects of the present disclosure. The operations of the method 1700 may be implemented by a UE or the UE's components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving control signaling indicating a set of multiple TCI states corresponding to a set of multiple TRPs, the control signaling indicating a first TCI state group of the set of multiple TCI states corresponding to a first set of TRPs of the set of multiple TRPs, and a second TCI state group of the set of multiple TCI states corresponding to a second set of TRPs of the set of multiple TRPs. The operations of 1705 may be performed in accordance with examples as disclosed herein. In some examples, aspects of the operations of 1705 may be performed by a control signaling receiving manager 925 as described with reference to FIG. 9.

At 1710, the method may include receiving a first mapping between the first TCI state group and a first set of DMRS ports, a first set of spatial multiplexing layers, or both, and a second mapping between the second TCI state group and a second set of DMRS ports, a second set of spatial multiplexing layers, or both. The operations of 1710 may be performed in accordance with examples as disclosed herein. In some examples, aspects of the operations of 1710 may be performed by a control signaling receiving manager 925 as described with reference to FIG. 9.

At 1715, the method may include monitoring for a phase-coherent joint transmission of a downlink message from the first set of TRPs in accordance with the first mapping, or from the second set of TRPs in accordance with the second mapping. The operations of 1715 may be performed in accordance with examples as disclosed herein. In some examples, aspects of the operations of 1715 may be performed by a CJT monitoring manager 945 as described with reference to FIG. 9.

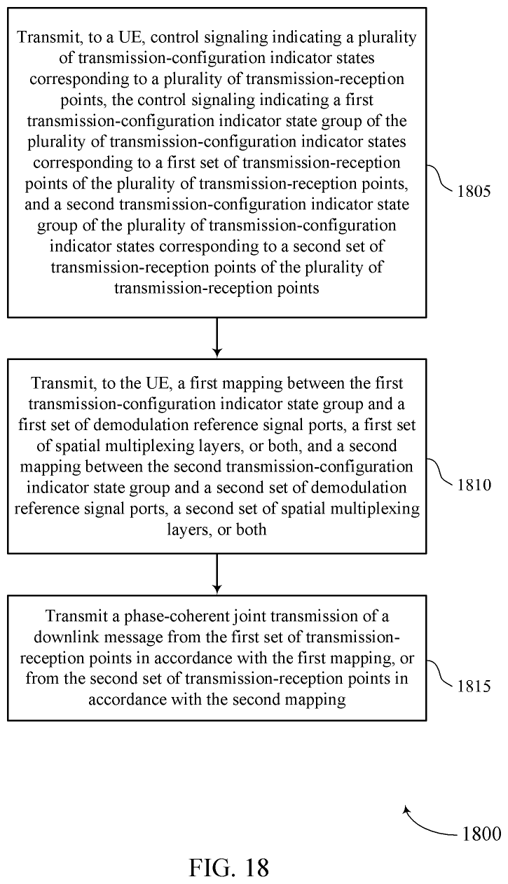

FIG. 18 shows a flowchart illustrating a method 1800 that supports techniques for CJT across multiple TRP sets in accordance with one or more aspects of the present disclosure. The operations of the method 1800 may be implemented by a network entity or the network entity's components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, to a UE, control signaling indicating a set of multiple TCI states corresponding to a set of multiple TRPs, the control signaling indicating a first TCI state group of the set of multiple TCI states corresponding to a first set of TRPs of the set of multiple TRPs, and a second TCI state group of the set of multiple TCI states corresponding to a second set of TRPs of the set of multiple TRPs. The operations of 1805 may be performed in accordance with examples as disclosed herein. In some examples, aspects of the operations of 1805 may be performed by a control signaling transmitting manager 1325 as described with reference to FIG. 13.

At 1810, the method may include transmitting, to the UE, a first mapping between the first TCI state group and a first set of DMRS ports, a first set of spatial multiplexing layers, or both, and a second mapping between the second TCI state group and a second set of DMRS ports, a second set of spatial multiplexing layers, or both. The operations of 1810 may be performed in accordance with examples as disclosed herein. In some examples, aspects of the operations of 1810 may be performed by a control signaling transmitting manager 1325 as described with reference to FIG. 13.

At 1815, the method may include transmitting a phase-coherent joint transmission of a downlink message from the first set of TRPs in accordance with the first mapping, or from the second set of TRPs in accordance with the second mapping. The operations of 1815 may be performed in accordance with examples as disclosed herein. In some examples, aspects of the operations of 1815 may be performed by a CJT transmitting manager 1340 as described with reference to FIG. 13.

The following provides an overview of aspects of the present disclosure:

Aspect 1: A method for wireless communication at a UE, comprising: receiving control signaling indicating a plurality of TRPs and a set of measurement resources; performing measurements for a plurality of reference signals received from the plurality of TRPs within the set of measurement resources; transmitting a CSI report including a first CSI part and a second CSI part, at least one of the first CSI part or the second CSI part indicating a first mapping between a first set of TRPs of the plurality of TRPs and a first set of spatial multiplexing layers, and indicating a second mapping between a second set of TRPs of the plurality of TRPs and a second set of spatial multiplexing layers based at least in part on the measurements; and receiving a phase-coherent joint transmission of a downlink message from the first set of TRPs in accordance with the first mapping, or from the second set of TRPs in accordance with the second mapping.

Aspect 2: The method of aspect 1, wherein the first CSI part comprises a joint indication of a quantity of TRPs within each of the first set of TRPs and the second set of TRPs, and comprises a corresponding joint rank indicator associated with each of the first set of TRPs and the second set of TRPs.

Aspect 3: The method of aspect 2, wherein the joint rank indicator comprises a first rank indicator associated with the first set of TRPs and a second rank indicator associated with the second set of TRPs.

Aspect 4: The method of any of aspects 1 through 3, wherein the second CSI part comprises an indication of TRPs included within the first set of TRPs, the second set of TRPs, or both.

Aspect 5: The method of aspect 4, wherein the indication of the TRPs comprises a bitmap, a combination index, or both.

Aspect 6: The method of any of aspects 1 through 5, further comprising: receiving, via the control signaling, an indication of the first set of TRPs and the second set of TRPs, wherein an indication of the first mapping and the second mapping is included in the first CSI part.

Aspect 7: The method of any of aspects 1 through 6, wherein the first set of TRPs is mutually exclusive with respect to the second set of TRPs, where the second set of TRPs includes fewer TRPs than the first set of TRPs, and where the CSI report indicates a bitmap, a combination index, or both, which indicates TRPs included within the second set of TRPs.

Aspect 8: The method of any of aspects 1 through 7, where the second set of TRPs includes fewer TRPs than the first set of TRPs, where the CSI report includes an indication of at least one TRP that is shared across the first set of TRPs and the second set of TRPs, and includes an indication of at least one additional TRP that is included in the second set of TRPs and which is not shared across the first set of TRPs and the second set of TRPs.

Aspect 9: A method for wireless communication at a network entity, comprising: transmitting, to a UE, control signaling indicating a plurality of TRPs and a set of measurement resources; transmitting a plurality of reference signals via the plurality of TRPs within the set of measurement resources; receiving, from the UE and based at least in part on the plurality of reference signals, a CSI report including a first CSI part and a second CSI part, at least one of the first CSI part or the second CSI part indicating a first mapping between a first set of TRPs of the plurality of TRPs and a first set of spatial multiplexing layers, and indicating a second mapping between a second set of TRPs of the plurality of TRPs and a second set of spatial multiplexing layers; and transmitting, to the UE, a phase-coherent joint transmission of a downlink message from the first set of TRPs in accordance with the first mapping, or from the second set of TRPs in accordance with the second mapping.

Aspect 10: The method of aspect 9, wherein the first CSI part comprises a joint indication of a quantity of TRPs within each of the first set of TRPs and the second set of TRPs, and comprises a corresponding joint rank indicator associated with each of the first set of TRPs and the second set of TRPs.

Aspect 11: The method of aspect 10, wherein the joint rank indicator comprises a first rank indicator associated with the first set of TRPs and a second rank indicator associated with the second set of TRPs.

Aspect 12: The method of any of aspects 9 through 11, wherein the second CSI part comprises an indication of TRPs included within the first set of TRPs, the second set of TRPs, or both.

Aspect 13: The method of aspect 12, wherein the indication of the TRPs comprises a bitmap, a combination index, or both.

Aspect 14: The method of any of aspects 9 through 13, further comprising: transmitting, via the control signaling, an indication of the first set of TRPs and the second set of TRPs, wherein an indication of the first mapping and the second mapping is included in the first CSI part.

Aspect 15: The method of any of aspects 9 through 14, wherein the first set of TRPs is mutually exclusive with respect to the second set of TRPs, where the second set of TRPs includes fewer TRPs than the first set of TRPs, and where the CSI report indicates a bitmap, a combination index, or both, which indicates TRPs included within the second set of TRPs.

Aspect 16: The method of any of aspects 9 through 15, where the second set of TRPs includes fewer TRPs than the first set of TRPs, where the CSI report includes an indication of at least one additional TRP that is included in the second set of TRPs and which is not shared across the first set of TRPs and the second set of TRPs.

Aspect 17: A method for wireless communication at a UE, comprising: receiving control signaling indicating a plurality of TCI states corresponding to a plurality of TRPs, the control signaling indicating a first TCI state group of the plurality of TCI states corresponding to a first set of TRPs of the plurality of TRPs, and indicating a second TCI state group of the plurality of TCI states corresponding to a second set of TRPs of the plurality of TRPs; receiving a first mapping between the first TCI state group and a first set of DMRS ports, a first set of spatial multiplexing layers, or both, and a second mapping between the second TCI state group and a second set of DMRS ports, a second set of spatial multiplexing layers, or both; and monitoring for a phase-coherent joint transmission of a downlink message from the first set of TRPs in accordance with the first mapping, or from the second set of TRPs in accordance with the second mapping.

Aspect 18: The method of aspect 17, wherein the control signaling indicates a third mapping between the first set of DMRS ports and the first set of spatial multiplexing layers, and indicates a fourth mapping between the second set of DMRS ports and the second set of spatial multiplexing layers, wherein the first mapping is based at least in part on the third mapping, and wherein the second mapping is based at least in part on the fourth mapping.

Aspect 19: The method of any of aspects 17 through 18 wherein the control signaling indicates a bitmap, a combination index, or both, that indicates TRPs included within the first set of TRPs, the second set of TRPs, or both.

Aspect 20: The method of any of aspects 17 through 19, wherein the control signaling indicates a bitmap, a combination index, or both, that indicates TCI states within the first TCI state group, the second TCI state group, or both.

Aspect 21: The method of any of aspects 17 through 20, wherein the control signaling comprises RRC signaling, DCI signaling, or both.

Aspect 22: The method of any of aspects 17 through 21, wherein the first TCI state group is mutually exclusive with respect to the second TCI state group, wherein the second transmission-configuration indicator state group includes fewer TCI states compared to the first transmission-configuration indicator state group, wherein the control signaling indicates a bitmap, a combination index, or both, which indicates TCI states included within the second TCI state group.

Aspect 23: The method of any of aspects 17 through 22, wherein the second transmission-configuration indicator state group includes fewer TCI states compared to the first transmission-configuration indicator state group, the method further comprising: receiving an indication of at least one TRP that is shared across the first set of TRPs and the second set of TRPs, and an indication of at least one additional TRP that is included in the second set of TRPs and which is not shared across the first set of TRPs and the second set of TRPs.

Aspect 24: A method for wireless communication at a network entity, comprising: transmitting, to a UE, control signaling indicating a plurality of TCI states corresponding to a plurality of TRPs, the control signaling indicating a first TCI state group of the plurality of TCI states corresponding to a first set of TRPs of the plurality of TRPs, and indicating a second TCI state group of the plurality of TCI states corresponding to a second set of TRPs of the plurality of TRPs; transmitting, to the UE, a first mapping between the first TCI state group and a first set of DMRS ports, a first set of spatial multiplexing layers, or both, and a second mapping between the second TCI state group and a second set of DMRS ports, a second set of spatial multiplexing layers, or both; and transmitting a phase-coherent joint transmission of a downlink message from the first set of TRPs in accordance with the first mapping, or from the second set of TRPs in accordance with the second mapping.

Aspect 25: The method of aspect 24, wherein the control signaling indicates a third mapping between the first set of DMRS ports and the first set of spatial multiplexing layers, and indicates a fourth mapping between the second set of DMRS ports and the second set of spatial multiplexing layers, wherein the first mapping is based at least in part on the third mapping, and wherein the second mapping is based at least in part on the fourth mapping.

Aspect 26: The method of any of aspects 24 through 25, wherein the control signaling indicates a bitmap, a combination index, or both, that indicates TRPs included within the first set of TRPs, the second set of TRPs, or both.

Aspect 27: The method of any of aspects 24 through 26, wherein the control signaling indicates a bitmap, a combination index, or both, that indicates TCI states within the first TCI state group, the second TCI state group, or both.

Aspect 28: The method of any of aspects 24 through 27, wherein the control signaling comprises RRC signaling, DCI signaling, or both.

Aspect 29: The method of any of aspects 24 through 28, wherein the first transmission-configuration indicator state group is mutually exclusive with respect to the second transmission-configuration indicator state group, wherein the second transmission-configuration indicator state group includes fewer TCI states compared to the first transmission-configuration indicator state group, wherein the control signaling indicates a bitmap, a combination index, or both, which indicates transmission-configuration indicator states included within the second transmission-configuration indicator state group.

Aspect 30: The method of any of aspects 24 through 29, wherein the second transmission-configuration indicator state group includes fewer TCI states compared to the first transmission-configuration indicator state group, the method further comprising: transmitting an indication of at least one TRP that is shared across the first set of TRPs and the second set of TRPs, and an indication of at least one additional TRP that is included in o the second set of TRPs and which is not shared across the first set of TRPs and the second set of TRPs.

Aspect 31: An apparatus for wireless communication at a UE, comprising a processor; memory coupled with the processor; and instructions stored in the memory and executable by the processor to cause the apparatus to perform a method of any of aspects 1 through 8.

Aspect 32: An apparatus for wireless communication at a UE, comprising at least one means for performing a method of any of aspects 1 through 8.

Aspect 33: A non-transitory computer-readable medium storing code for wireless communication at a UE, the code comprising instructions executable by a processor to perform a method of any of aspects 1 through 8.

Aspect 34: An apparatus for wireless communication at a network entity, comprising a processor; memory coupled with the processor; and instructions stored in the memory and executable by the processor to cause the apparatus to perform a method of any of aspects 9 through 16.

Aspect 35: An apparatus for wireless communication at a network entity, comprising at least one means for performing a method of any of aspects 9 through 16.

Aspect 36: A non-transitory computer-readable medium storing code for wireless communication at a network entity, the code comprising instructions executable by a processor to perform a method of any of aspects 9 through 16.

Aspect 37: An apparatus for wireless communication at a UE, comprising a processor; memory coupled with the processor; and instructions stored in the memory and executable by the processor to cause the apparatus to perform a method of any of aspects 17 through 23.

Aspect 38: An apparatus for wireless communication at a UE, comprising at least one means for performing a method of any of aspects 17 through 23.

Aspect 39: A non-transitory computer-readable medium storing code for wireless communication at a UE, the code comprising instructions executable by a processor to perform a method of any of aspects 17 through 23.

Aspect 40: An apparatus for wireless communication at a network entity, comprising a processor; memory coupled with the processor; and instructions stored in the memory and executable by the processor to cause the apparatus to perform a method of any of aspects 24 through 30.

Aspect 41: An apparatus for wireless communication at a network entity, comprising at least one means for performing a method of any of aspects 24 through 30.

Aspect 42: A non-transitory computer-readable medium storing code for wireless communication at a network entity, the code comprising instructions executable by a processor to perform a method of any of aspects 24 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
receive control signaling indicating a plurality of transmission-reception points and a set of measurement resources;
perform measurements for a plurality of reference signals received from the plurality of transmission-reception points within the set of measurement resources;
transmit a channel state information (CSI) report including a first CSI part and a second CSI part, at least one of the first CSI part or the second CSI part indicating a first mapping between a first set of transmission-reception points of the plurality of transmission-reception points and a first set of spatial multiplexing layers, and indicating a second mapping between a second set of transmission-reception points of the plurality of transmission-reception points and a second set of spatial multiplexing layers based at least in part on the measurements; and
receive a phase-coherent joint transmission of a downlink message from the first set of transmission-reception points in accordance with the first mapping, or from the second set of transmission-reception points in accordance with the second mapping.

2. The apparatus of claim 1, wherein the first CSI part comprises a joint indication of a quantity of transmission-reception points within each of the first set of transmission-reception points and the second set of transmission-reception points, and comprises a corresponding joint rank indicator associated with each of the first set of transmission-reception points and the second set of transmission-reception points.

3. The apparatus of claim 2, wherein the joint rank indicator comprises a first rank indicator associated with the first set of transmission-reception points and a second rank indicator associated with the second set of transmission-reception points.

4. The apparatus of claim 1, wherein the second CSI part comprises an indication of transmission-reception points included within the first set of transmission-reception points, the second set of transmission-reception points, or both.

5. The apparatus of claim 4, wherein the indication of the transmission-reception points comprises a bitmap, a combination index, or both.

6. The apparatus of claim 1, wherein the instructions are further executable by the processor to cause the apparatus to:
receive, via the control signaling, an indication of the first set of transmission-reception points and the second set of transmission-reception points, wherein an indication of the first mapping and the second mapping is included in the first CSI part.

7. The apparatus of claim 1, wherein the first set of transmission-reception points is mutually exclusive with respect to the second set of transmission-reception points, wherein the second set of transmission-reception points includes fewer transmission-reception points than the first set of transmission-reception points, wherein the CSI report indicates a bitmap, a combination index, or both, which indicates transmission-reception points included within the second set of transmission-reception points.

8. The apparatus of claim 1, wherein the second set of transmission-reception points includes fewer transmission-reception points than the first set of transmission-reception points, wherein the CSI report comprises an indication of at least one transmission-reception point that is shared across the first set of transmission-reception points and the second set of transmission-reception points, and comprises an indication of at least one additional transmission-reception point that is included in the second set of transmission-reception points and which is not shared across the first set of transmission-reception points and the second set of transmission-reception points.

9. An apparatus for wireless communication at a network entity, comprising:
a processor;
memory coupled with the processor; and
instructions stored in the memory and executable by the processor to cause the apparatus to:
transmit, to a user equipment (UE), control signaling indicating a plurality of transmission-reception points and a set of measurement resources;
transmit a plurality of reference signals via the plurality of transmission-reception points within the set of measurement resources;
receive, from the UE and based at least in part on the plurality of reference signals, a channel state information (CSI) report including a first CSI part and a second CSI part, at least one of the first CSI part or the second CSI part indicating a first mapping between a first set of transmission-reception points of the plurality of transmission-reception points and a first set of spatial multiplexing layers, and indicating a second mapping between a second set of transmission-reception points of the plurality of transmission-reception points and a second set of spatial multiplexing layers; and
transmit, to the UE, a phase-coherent joint transmission of a downlink message from the first set of transmission-reception points in accordance with the first mapping, or from the second set of transmission-reception points in accordance with the second mapping.

10. The apparatus of claim 9, wherein the first CSI part comprises a joint indication of a quantity of transmission-reception points within each of the first set of transmission-reception points and the second set of transmission-reception points, and comprises a corresponding joint rank indicator associated with each of the first set of transmission-reception points and the second set of transmission-reception points.

11. The apparatus of claim 10, wherein the joint rank indicator comprises a first rank indicator associated with the first set of transmission-reception points and a second rank indicator associated with the second set of transmission-reception points.

12. The apparatus of claim 9, wherein the second CSI part comprises an indication of transmission-reception points included within the first set of transmission-reception points, the second set of transmission-reception points, or both.

13. The apparatus of claim 12, wherein the indication of the transmission-reception points comprises a bitmap, a combination index, or both.

14. The apparatus of claim 9, wherein the instructions are further executable by the processor to cause the apparatus to:
transmit, via the control signaling, an indication of the first set of transmission-reception points and the second set of transmission-reception points, wherein the indication of the first mapping and the second mapping is included in the first CSI part.

15. The apparatus of claim 9, wherein the first set of transmission-reception points is mutually exclusive with respect to the second set of transmission-reception points, wherein the second set of transmission-reception points includes fewer transmission-reception points than the first set of transmission-reception points, wherein the CSI report indicates a bitmap, a combination index, or both, which indicates transmission-reception points included within the second set of transmission-reception points.

16. The apparatus of claim 9, wherein the second set of transmission-reception points includes fewer transmission-reception points than the first set of transmission-reception points, wherein the CSI report comprises an indication of at least one transmission-reception point that is shared across the first set of transmission-reception points and the second set of transmission-reception points, and comprises an indication of at least one additional transmission-reception point that is included in the second set of transmission-reception points and which is not shared across the first set of transmission-reception points and the second set of transmission-reception points.

17. An apparatus for wireless communication at a user equipment (UE), comprising:
a processor;
memory coupled with the processor; and
instructions stored in the memory and executable by the processor to cause the apparatus to:
receive control signaling indicating a plurality of transmission-configuration indicator states corresponding to a plurality of transmission-reception points, the control signaling indicating a first transmission-configuration indicator state group of the plurality of transmission-configuration indicator states corresponding to a first set of transmission-reception points of the plurality of transmission-reception points, and indicating a second transmission-configuration indicator state group of the plurality of transmission-configuration indicator states corresponding to a second set of transmission-reception points of the plurality of transmission-reception points;
receive a first mapping between the first transmission-configuration indicator state group and a first set of demodulation reference signal ports, a first set of spatial multiplexing layers, or both, and a second mapping between the second transmission-configuration indicator state group and a second set of demodulation reference signal ports, a second set of spatial multiplexing layers, or both; and
monitor for a phase-coherent joint transmission of a downlink message from the first set of transmission-reception points in accordance with the first mapping, or from the second set of transmission-reception points in accordance with the second mapping.

18. The apparatus of claim 17, wherein the control signaling indicates a third mapping between the first set of demodulation reference signal ports and the first set of spatial multiplexing layers, and indicates a fourth mapping between the second set of demodulation reference signal ports and the second set of spatial multiplexing layers, wherein the first mapping is based at least in part on the third mapping, and wherein the second mapping is based at least in part on the fourth mapping.

19. The apparatus of claim 17, wherein the control signaling indicates a bitmap, a combination index, or both, that indicates transmission-reception points included within the first set of transmission-reception points, the second set of transmission-reception points, or both.

20. The apparatus of claim 17, wherein the control signaling indicates a bitmap, a combination index, or both, that indicates transmission-configuration indicator states within the first transmission-configuration indicator state group, the second transmission-configuration indicator state group, or both.

21. The apparatus of claim 17, wherein the control signaling comprises radio resource control signaling, downlink control information signaling, or both.

22. The apparatus of claim 17, wherein the first transmission-configuration indicator state group is mutually exclusive with respect to the second transmission-configuration indicator state group, wherein the second transmission-configuration indicator state group includes fewer transmission configuration indicator states compared to the first transmission-configuration indicator state group, wherein the control signaling indicates a bitmap, a combination index, or both, which indicates transmission-configuration indicator states included within the second transmission-configuration indicator state group.

23. The apparatus of claim 17, wherein the second transmission-configuration indicator state group includes fewer transmission configuration indicator states compared to the first transmission-configuration indicator state group, wherein the instructions are further executable by the processor to cause the apparatus to:
receive an indication of at least one transmission-reception point that is shared across the first set of transmission-reception points and the second set of transmission-reception points, and an indication of at least one additional transmission-reception point that is included in the second set of transmission-reception points and which is not shared across the first set of transmission-reception points and the second set of transmission-reception points.

24. An apparatus for wireless communication at a network entity, comprising:
a processor;
memory coupled with the processor; and
instructions stored in the memory and executable by the processor to cause the apparatus to:
transmit, to a user equipment (UE), control signaling indicating a plurality of transmission-configuration indicator states corresponding to a plurality of transmission-reception points, the control signaling indicating a first transmission-configuration indicator state group of the plurality of transmission-configuration indicator states corresponding to a first set of transmission-reception points of the plurality of transmission-reception points, and indicating a second transmission-configuration indicator state group of the plurality of transmission-configuration indicator states corresponding to a second set of transmission-reception points of the plurality of transmission-reception points;
transmit, to the UE, a first mapping between the first transmission-configuration indicator state group and a first set of demodulation reference signal ports, a first set of spatial multiplexing layers, or both, and a second mapping between the second transmission-configuration indicator state group and a second set of demodulation reference signal ports, a second set of spatial multiplexing layers, or both; and
transmit a phase-coherent joint transmission of a downlink message from the first set of transmission-reception points in accordance with the first mapping, or from the second set of transmission-reception points in accordance with the second mapping.

25. The apparatus of claim 24, wherein the control signaling indicates a third mapping between the first set of demodulation reference signal ports and the first set of spatial multiplexing layers, and indicates a fourth mapping between the second set of demodulation reference signal ports and the second set of spatial multiplexing layers, wherein the first mapping is based at least in part on the third mapping, and wherein the second mapping is based at least in part on the fourth mapping.

26. The apparatus of claim 24, wherein the control signaling indicates a bitmap, a combination index, or both, that indicates transmission-reception points included within the first set of transmission-reception points, the second set of transmission-reception points, or both.

27. The apparatus of claim 24, wherein the control signaling indicates a bitmap, a combination index, or both, that indicates transmission-configuration indicator states within the first transmission-configuration indicator state group, the second transmission-configuration indicator state group, or both.

28. The apparatus of claim 24, wherein the control signaling comprises radio resource control signaling, downlink control information signaling, or both.

29. The apparatus of claim 24, wherein the first transmission-configuration indicator state group is mutually exclusive with respect to the second transmission-configuration indicator state group, wherein the second transmission-configuration indicator state group includes fewer transmission configuration indicator states compared to the first transmission-configuration indicator state group, wherein the control signaling indicates a bitmap, a combination index, or both, which indicates transmission-configuration indicator states included within the second transmission-configuration indicator state group.

30. The apparatus of claim 24, wherein the second transmission-configuration indicator state group includes fewer transmission configuration indicator states compared to the first transmission-configuration indicator state group, wherein the instructions are further executable by the processor to cause the apparatus to:
transmit an indication of at least one transmission-reception point that is shared across the first set of transmission-reception points and the second set of transmission-reception points, and an indication of at least one additional transmission-reception point that is included in the second set of transmission-reception points and which is not shared across the first set of transmission-reception points and the second set of transmission-reception points.
